(19) United States
(12) Patent Application Publication
(10) Pub. No.: US 2020/0351040 A1
(43) Pub. Date: Nov. 5, 2020

(54) LOW LATENCY UPLINK COMMUNICATION

(71) Applicant: Qualcomm Incorporated, San Diego, CA (US)

(72) Inventors: Sitaramanjaneyulu Kanamarlapudi, San Diego, CA (US); Arnaud Meylan, San Diego, CA (US); Vishal Dalmiya, San Diego, CA (US); Xinchen Zhang, San Diego, CA (US)

(21) Appl. No.: 16/862,124

(22) Filed: Apr. 29, 2020

Related U.S. Application Data
(60) Provisional application No. 62/841,148, filed on Apr. 30, 2019.

(51) Int. Cl. H04L 5/00; H04W 72/04; H04W 12/10

(52) U.S. Cl. CPC H04L 5/001; H04W 12/10; H04W 72/04

(57) ABSTRACT

Methods, systems, and apparatuses for wireless communication are disclosed. In one aspect, a user equipment (UE) identifies a plurality of packets to send to a receiver. The packets may include radio link control (RLC) layer protocol data units (PDUs) and each may be associated with a logical channel for transmission and have a corresponding sequence number (SN). The UE may adjust a manner of assembling a transport block based at least in part on a logical channel configuration of the packets, whether the packets include RLC segments, an uplink transmission timing requirement, a number and size of transport blocks to be processed concurrently, a resource allocation associated with an uplink grant, or any combination thereof.

The present Application for Patent claims the benefit of U.S. Provisional Patent Application No. 62/841,148 by ZHANG et al., entitled “LOW LATENCY UPLINK COMMUNICATION,” filed Apr. 30, 2019, assigned to the assignee hereof, and expressly incorporated by reference herein.

### BACKGROUND

The present disclosure relates generally to wireless communications and, more specifically, to uplink transmissions by a user equipment.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system, or a New Radio (NR) system). A wireless multiple-access communication system may include a number of base stations or access network nodes, each simultaneously supporting communication for multiple communication devices also known as user equipment (UE).

Multiple access technologies have been adopted in various telecommunication standards to provide a common protocol that enables different wireless devices to communicate on a municipal, regional, national, and even global level. For example, a fifth generation (5G) wireless communications technology (which may be referred to as new radio (NR)) is being developed to expand and support diverse usage scenarios and applications with respect to current mobile network generations. Different aspects of 5G communications technology may include: enhanced mobile broadband (eMBB) addressing human-centric use cases for access to multimedia content, services and data; ultra-reliable-low latency communications (URLLC) with certain specifications for latency and reliability; and massive machine type communications, which can allow for a very large number of connected devices and transmission of a relatively low volume of non-delay-sensitive information. As the demand for such different types of service increases, however, further improvements in NR communications technology and beyond are needed.

### SUMMARY

Generally, the present disclosure provides an efficient method of transport block assembly and transmission which accommodates use of integrity protection with segmented packets. A UE may compute an integrity protection code for packets to be sent to a receiver. For a segmented first packet, the UE may identify an end segment of the first packet and place it in a transport block after another packet. In some examples, the transport block may be of the same logical channel and the other packet may have a larger protocol data unit sequence number than the first packet. As another example, the UE may identify an end segment of the first packet and place it in at the beginning of a different transport block in a different time slot or at the end of a different transport block in the same time slot. The UE may place a start segment of the first packet before another packet of the same logical channel having a smaller protocol data unit sequence number than the first packet. The first packet start and end segments may be placed in different transport blocks that are concurrently assembled such that an interdependency created by computing the integrity protection code is mitigated and parallel processing of the transport blocks can occur. Transmission timing of the transport blocks may be subject to strict requirements. Formatting of the transport blocks may also be subject to strict requirements.

Different transport blocks may be sent on different carriers in a carrier aggregation configuration, in different transport blocks for multiple-input multiple-output (MIMO) configurations, or on resources associated with different services such as the eMBB service or the URLLC service. In some aspects, assembly of transport blocks may be performed in a streaming mode and placement of start and end segments may attempt to maximize a timing difference between the last bit of a starting segment and the first bit of an end segment.

A method of wireless communication performed by a UE is disclosed. In one aspect, the method may include identifying radio link control (RLC) protocol data units (PDUs) to send to a receiver, each RLC PDU being associated with a logical channel and comprising a sequence number of the logical channel generated by an RLC protocol entity of the UE. The method may include determining whether use of an integrity protection code is configured for a first logical channel, the first logical channel comprising a plurality of RLC PDUs in the identified RLC PDUs, including a first start segment and a first end segment associated with a first sequence number. The method may also include arranging, based on a result of the determining, a first set of RLC PDUs of the identified RLC PDUs in a first media access control (MAC) transport block (TB), wherein the first start segment is placed at the end of the first MAC TB. The method may include arranging, based on a result of the determining, a second set of RLC PDUs of the identified RLC PDUs in a second MAC TB, wherein the first end segment is placed at the beginning of the second MAC TB when the second MAC TB is in a different transmission time interval than the first MAC TB or the first end segment is placed at the end of the second MAC TB when the second MAC TB is in a same transmission time interval as the first MAC TB. The method may also include sending the first MAC TB and the second MAC TB to the receiver.

An apparatus is also disclosed. The apparatus may be a UE or a part of a UE. In one aspect, the apparatus includes a processor, memory coupled with the processor, instructions stored in the memory and operable, when executed by the processor, to identify RLC PDUs to send to a receiver, each RLC PDU being associated with a logical channel and comprising a sequence number of the logical channel generated by an RLC protocol entity of the UE. The instructions may also be executable by the processor to determine whether use of an integrity protection code is configured for a first logical channel, the first logical channel comprising a plurality of RLC PDUs in the identified RLC PDUs, including a first start segment and a first end segment associated with a first sequence number and arrange, based on a result of the determining, a first set of RLC PDUs of the identified RLC PDUs in a first MAC TB, wherein the first start segment is placed at the end of the first MAC TB. The instructions may be executable by the processor to arrange, based on a result of the determining, a second set of RLC PDUs of the identified RLC PDUs in a second MAC TB, wherein the first end segment is placed at the beginning of the second MAC TB when the second MAC TB is in a different transmission time interval than the first MAC TB or the first end segment is placed at the end of the second MAC TB when the second MAC TB is in a same transmission time interval as the first MAC TB. The instructions may also be executable by the processor to send the first MAC TB and the second MAC TB to the receiver and identify RLC PDUs to the receiver.

In some examples of the method, apparatus, and non-transitory computer-readable medium described above, sending the first MAC TB and the second MAC TB to the receiver may further include sending the first MAC TB on a first component carrier in a carrier aggregation configuration of the UE and sending the second MAC TB on the first component carrier in the carrier aggregation configuration of the UE. In some examples, sending the first MAC TB and the second MAC TB to the receiver may further include sending the first MAC TB on a first component carrier in a carrier aggregation configuration of the UE and sending the second MAC TB on a second component carrier in the carrier aggregation configuration of the UE.

In some examples of the method, apparatus, and non-transitory computer-readable medium described above, the second MAC TB is in a different transmission time interval than the first MAC TB, and the plurality of RLC PDUs is a first plurality of RLC PDUs, and the UE may determine whether use of the integrity protection code is configured for a second logical channel, the second logical channel comprising a second plurality of RLC PDUs in the identified RLC PDUs, including a second start segment and a second end segment associated with a second sequence number and arrange, based on a result of the determining whether use of the integrity protection code is configured for the second logical channel, the second end segment in the second MAC TB after the first end segment. In some examples of the method, apparatus, and non-transitory computer-readable medium described above, the UE may arrange, based on the result of the determining whether use of the integrity protection code is configured for the second logical channel, the second start segment in a third MAC TB, wherein the third MAC TB is in the second logical channel.

In some examples of the method, apparatus, and non-transitory computer-readable medium described above, the UE may arrange the first set of RLC PDUs in a consecutive order of sequence numbers in the first TB when it is determined that use of the integrity protection code is not enabled for the first logical channel.

In some examples of the method, apparatus, and non-transitory computer-readable medium described above, sending the first MAC TB and the second MAC TB to the receiver may further include sending the first MAC TB on first resources allocated by a first resource grant associated with a first service type and sending the second TB on second resources associated with a second service type which overlap, at least in part, with the first resources. In some examples, arranging the first set of RLC PDUs, the second set of RLC PDUs, or both, may be based at least in part on a logical channel configuration of the identified RLC PDUs, a segmentation of the identified RLC PDUs, an uplink transmission timing requirement associated with the first MAC TB, a number of MAC TBs to be processed concurrently, a service type for the uplink transmission, a resource allocation for the uplink transmission, or any combination thereof. In some examples, the integrity protection code is at a packet data convergence protocol (PDCP) level.

A method of wireless communication performed by a user equipment is disclosed. In one aspect, the method may include identifying radio link control (RLC) protocol data units (PDUs) to send to a receiver. Each of the RLC PDUs may have one or more segments, including a start segment, an end segment, or an entire packet, and each may have a corresponding sequence number (SN) generated by an RLC protocol entity of the UE. The method may include determining that integrity protection is enabled for a first logical channel. The method may include placing, in a transport block, an RLC PDU of the first logical channel with SN=M and containing an end segment after an RLC PDU with SN>M and sending the transport block to a receiver. In some aspects, the method may also include placing, in a second transport block, an RLC PDU of the first logical channel with SN=M and containing a start segment before an RLC PDU of the first logical channel with SN<M and sending the second transport block to the receiver.

An apparatus is also disclosed. The apparatus may be a UE or a part of a UE. In one aspect, the apparatus includes means for identifying RLC PDUs to send to a receiver. Each RLC PDU may have one or more segments including a start segment, an end segment, or an entire packet, and each may have a corresponding SN generated by an RLC protocol entity of the apparatus. The apparatus may include means for determining that integrity protection is enabled for a first logical channel. The apparatus may also include means for placing, in a transport block, an RLC PDU of the first logical channel with SN=M and containing an end segment after an RLC PDU with SN>M and means for sending the transport block to the receiver. In one aspect, the means for placing are configured to place, in a second transport block, an RLC PDU of the first logical channel with SN=M and containing a start segment before an RLC PDU of the first logical channel with SN<M and the means for sending are configured to send the second transport block to the receiver.

Another apparatus is disclosed. The apparatus may be a UE or a part of a UE. In one aspect, the apparatus includes a processor and a memory coupled to the processor. The apparatus may include instructions stored in the memory and operable, when executed by the processor, to identify RLC PDUs to send to a receiver. Each of the RLC PDUs may have one or more segments including a start segment, an end segment, or an entire packet, and each may have a corresponding SN generated by an RLC protocol entity of the apparatus. The instructions, when executed by the processor, may be operable to determine that integrity protection is enabled for a first logical channel and to place, in a transport block, an RLC PDU of the first logical channel with SN=M and containing an end segment after an RLC PDU with SN>M. When executed by the processor, the instructions may be operable to send the transport block to the receiver. In one aspect, the instructions stored in the memory are operable, when executed by the processor, to place, in a second transport block, an RLC PDU of the first logical channel with SN=M and containing a start segment before an RLC PDU of the first logical channel with SN<M, and to send the second transport block to the receiver.

A non-transitory computer readable medium storing code for wireless communication is disclosed. The code may comprise instructions executable by a processor of a UE to identify RLC PDUs to send to a receiver. Each of the RLC PDUs may have one or more segments including a start segment, an end segment, or an entire packet, and each may have a corresponding SN generated by an RLC protocol entity of the UE. The code may comprise instructions executable by the processor to determine that integrity protection is enabled for a first logical channel. The code may comprise instructions executable by the processor to place, in a transport block, an RLC PDU of the first logical channel with SN=M and containing an end segment after an RLC PDU with SN>M and to send the transport block to the receiver. In one aspect, the code may also comprise instructions executable by the processor to place, in a second transport block, an RLC PDU of the first logical channel with SN=M and containing a start segment before an RLC PDU of the first logical channel with SN<M, and to send the second transport block to the receiver.

A method of wireless communication performed by a user equipment is disclosed. In one aspect, the method may include identifying RLC PDUs to send to a receiver. Each RLC PDU may be associated with a logical channel and may comprise a SN of the logical channel generated by an RLC protocol entity of the UE. The method may include determining whether use of an integrity protection code is configured for a first logical channel. The first logical channel may comprise a plurality of RLC PDUs in the identified RLC PDUs, including a first start segment and a first end segment associated with a first SN. The method may include arranging, based on a result of the determining, a first set of RLC PDUs of the identified RLC PDUs in a first transport block (TB) wherein the first end segment is placed after a second RLC PDU of the first logical channel having a second SN that is larger than the first SN and sending the first TB to the receiver. In some aspects, the method may include arranging a second set of RLC PDUs of the identified RLC PDUs in a second TB wherein the first start segment is placed before a third RLC PDU in the identified RLC PDUs having a third SN that is smaller than the first SN and sending the second TB to the receiver.

An apparatus is disclosed. The apparatus may be UE or a part of a UE. In one aspect, the apparatus includes means for identifying RLC PDUs to send to a receiver. Each RLC PDU may be associated with a logical channel and comprise a SN of the logical channel generated by an RLC protocol entity of the apparatus. The apparatus may include means for determining whether use of an integrity protection code is configured for a first logical channel. The first logical channel may include a plurality of RLC PDUs in the identified RLC PDUs, including a first start segment and a first end segment associated with a first SN. The apparatus may include means for arranging, based on a result of the determining, a first set of RLC PDUs in the identified RLC PDUs in a first TB wherein the first end segment is placed after a second RLC PDU of the first logical channel having a second SN that is larger than the first SN. The apparatus may include means for sending the first TB to the receiver. In one aspect, the means for arranging are configured to arrange a second set of RLC PDUs of the identified RLC PDUs in a second TB, wherein the first start segment is placed before a third RLC PDU in the identified RLC PDUs having a third SN that is smaller than the first SN. The means for sending may be configured to send the second TB to the receiver.

Another apparatus is disclosed. The apparatus may be a UE or a part of a UE. In one aspect, the apparatus includes a processor and a memory coupled to the processor. The apparatus may include instructions stored in the memory and operable, when executed by the processor, to identify RLC PDUs to send to a receiver. Each RLC PDU may be associated with a logical channel and comprise a SN of the logical channel generated by an RLC protocol entity of the apparatus. When executed by the processor, the instructions may be operable to determine whether use of an integrity protection code is configured for a first logical channel. The first logical channel may comprise a plurality of RLC PDUs in the identified RLC PDUs, including a first start segment and a first end segment associated with a first SN. The instructions may further be operable to arrange, based on a result of the determining, a first set of RLC PDUs of the identified RLC PDUs in a first TB, wherein the first end segment is placed after a second RLC PDU of the first logical channel having a second SN that is larger than the first SN. The instructions may be operable to send the first TB to the receiver. In one aspect, the instructions are operable, when executed by the processor, to arrange a second set of RLC PDUs of the identified RLC PDUs in a second TB, wherein the first start segment is placed before a third RLC PDU in the identified RLC PDUs having a third SN that is smaller than the first SN. The instructions may be operable to send the second TB to the receiver.

In some examples of the method, apparatus, and non-transitory computer-readable medium described above, the UE may send the first TB to the receiver on a first component carrier in a carrier aggregation configuration of the UE, and may send the second TB to the receiver on a second component carrier in the carrier aggregation configuration. In some examples, the UE may send the first TB to the receiver on first resources allocated by a first resource grant associated with a first service type, and send the second TB to the receiver on second resources associated with a second service type which overlap, at least in part, with the first resources. The first service may include an eMBB service and the second service may include an URLLC service, and at least a portion of the first TB may be preempted by transmission of the second TB. In some examples, the wireless device may arrange the first set of RLC PDUs, the second set of RLC PDUs, or both, based at least in part on a logical channel configuration of the identified RLC PDUs, a segmentation of the identified RLC PDUs, an uplink transmission timing requirement associated with the first TB, a number of TBs to be processed concurrently, a service type for the uplink transmission, a resource allocation for the uplink transmission, or any combination thereof. In some examples, the RLC protocol entity of the UE may generate the SNs in a consecutive order.

### BRIEF DESCRIPTION OF THE DRAWINGS

FIG. 1 shows an example of a system for wireless communication in accordance with aspects of the present disclosure.

FIG. 2 shows an example radio protocol architecture in accordance with the present disclosure.

FIG. 3 shows additional aspects of the radio protocol architecture depicted in FIG. 2 in accordance with the present disclosure.

FIG. 4 shows an example Packet Data Convergence Protocol (PDCP) data PDU structure in accordance with the present disclosure.

FIGS. 5A-5C and 6A-6D show example aspects of transport block assembly in accordance with the present disclosure.

FIGS. 7-9 are block diagrams of a wireless device that supports low latency uplink transmission in accordance with the present disclosure.

FIGS. 10 and 11 illustrate example methods of wireless communication in accordance with the present disclosure.

### DETAILED DESCRIPTION

Advanced wireless communication systems such as New Radio (NR) from the 3^{rd} Generation Partnership Project (3GPP) will introduce new service types and implement strict timing requirements for the transmission of data. With these strict timing requirements, the processing demands placed upon user equipment will increase and new approaches to uplink data transmission may be needed. In NR, data bearer integrity protection (DRB IP) is a mandatory capability for all UEs. At the radio resource control (RRC) level, data bearer integrity protection may be an optionally configurable parameter. DRB IP may have strict size and timing requirements.

In particular, to meet the size and timing requirements, a UE may need to compute an integrity protection code for a packet while also performing segmentation of the packet and transport block assembly. This may present a significant challenge as computing the integrity protection code can interfere with parallel processing of transport blocks. The disclosed techniques can mitigate these issues by creating separation from a transmission timing perspective between starting segments and end segments of a packet for which the UE computes an integrity protection code.

As disclosed herein, a UE may identify a plurality of packets for transmission to a receiver and identify those for which an integrity protection code is to be generated. For packets which require an integrity protection code, the UE can determine whether the packets have been segmented by upper layer processing. If the packets have not been segmented, the UE may compute the integrity protection code and assemble transport blocks according to protocol data unit sequence numbers so as to avoid a placement with excessive non-consecutive sequence numbers. However, for segmented packets, the UE may identify a starting and end segment and may place the segments out-of-order with respect to the protocol data unit sequence numbers of other packets of a same or different logical channel.

In one aspect, a starting segment for a packet may be placed at or near an end of a first MAC subPDU of a first MAC transport block. This placement of the starting segment may follow other packets having smaller protocol data unit sequence numbers. An end segment for the packet may be placed in a different transport block in order to reduce delays caused by computing the integrity protection code for an end packet while computing earlier packets during the assembly of the respective transport blocks. The end segment of the packet may be placed at the beginning of another transport block in a different time slot and may precede other packets having smaller protocol data unit sequence numbers. Alternatively, the end segment of the packet may be placed at the end of another transport block in the same time slot such that the start segment and the end segment may be proceeded at the same time. In another alternative, the end segment of the packet may be placed at the beginning of another transport block in a different logical channel.

In another aspect, a starting segment for a packet may be placed at or near a first MAC subPDU of a first transport block. This placement of the starting segment in the first transport block may precede other packets having smaller protocol data unit sequence numbers. With a streaming approach to transport block assembly, placement of the starting segment in the transport block may correspond to transmission on a first symbol in a resource allocation of the UE. The end segment of the packet may also be placed out-of-order with respect to the protocol data unit sequence numbers of other packets of a same logical channel. In one aspect, the end segment is placed in a transport block and follows other packets of the same logical channel which have larger protocol sequence numbers.

By creating separation in time and controlling placement of the segments, delay due to the computation of the integrity protection code in the assembly of the respective transport blocks may be reduced or avoided and the operations may be pipelined thereby potentially reducing device hardware requirements and cost. Among other aspects, this technique can be used advantageously with carrier aggregation and in mixed service type scenarios in which high priority transmissions may interrupt or preempt lower priority services.

Aspects of the disclosure are initially described in the context of a wireless communications system and relate to uplink transmission in which segmented packets are assembled into transport blocks with concurrent processing. Aspects of the disclosure are further illustrated by and described with reference to apparatus diagrams, system diagrams, and flowcharts that relate to the foregoing. While aspects and embodiments are described in this application using various illustrations and examples, those skilled in the art will understand that additional implementations and use cases may come about in many different arrangements and scenarios. The descriptions herein may be implemented across different platforms, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.).

Implementations may range a spectrum from chip-level or modular components to non-modular, non-chip-level implementations and further to aggregate, distributed, or original equipment manufacturer (OEM) devices or systems incorporating one or more aspects of the present disclosure. In some practical settings, devices incorporating described aspects and features may also include additional components and features for implementation and practice of claimed and described embodiments. For example, transmission and reception of wireless signals may include a number of components for analog and digital purposes (e.g., hardware components including antenna, RF-chains, power amplifiers, modulators, buffer, filters, processor(s), interleaver, adders/summers, etc.). It is intended that aspects of the present disclosure herein may be practiced in a wide variety of devices, chip-level components, systems, distributed arrangements, end-user devices, etc. of varying sizes, shapes, and constitution.

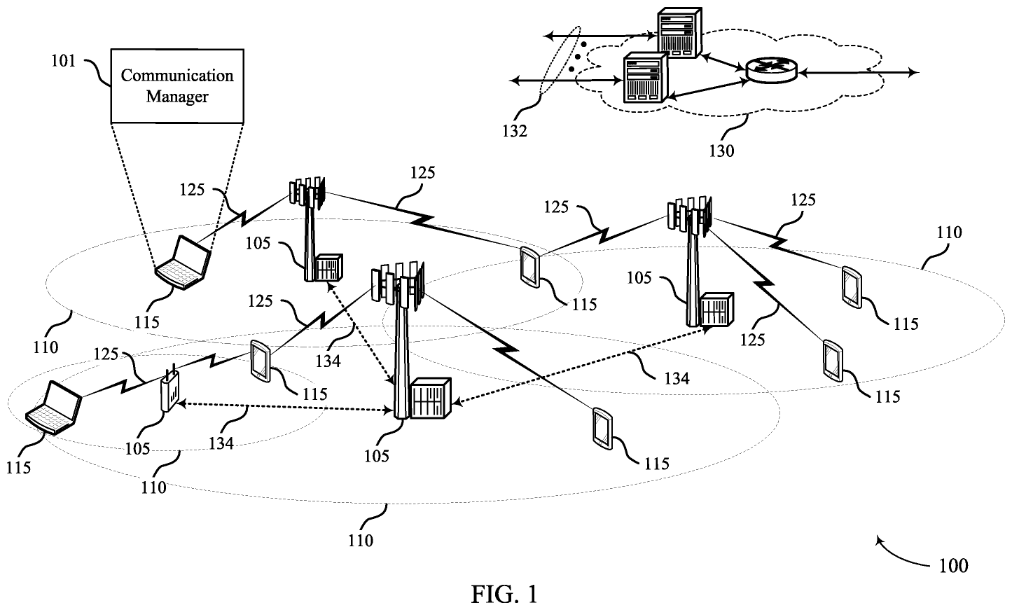

FIG. 1 illustrates an example of a system 100 in accordance with various aspects of the present disclosure. System 100 includes base stations 105, UEs 115, and a core network 130. In some examples, system 100 may be an LTE network, an LTE-Advanced (LTE-A) network, or a NR network. In some cases, system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. As described herein, a base station 105 may include or may be referred to as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. System 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may include one or more carriers. Communication links 125 shown in system 100 may include uplink transmissions from a UE 115 to a base station 105, or downlink transmissions, from a base station 105 to a UE 115. Downlink transmissions may also be called forward link transmissions while uplink transmissions may also be called reverse link transmissions.

The geographic coverage area 110 for a base station 105 may be divided into sectors making up only a portion of a corresponding geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. System 100 may include, for example, a heterogeneous LTE/LTE-A or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, the cells may support different service and/or device types (e.g., machine-type communication (MTC), narrowband Internet-of-Things (NB-IoT), eMBB, URLLC, and others). In some cases, the term “cell” may refer to a portion of a geographic coverage area 110 (e.g., a sector) over which the logical entity operates.

UEs 115 may be dispersed throughout system 100, and each UE 115 may be stationary or mobile. A UE 115 may also be referred to as a wireless device, a mobile device, a mobile station, a remote device, a handheld device, or a subscriber device, or some other suitable terminology, where the “device” may also be referred to as a unit, a station, a terminal, or a client. A UE 115 may also be a electronic device such as a cellular phone, a personal digital assistant (PDA), a tablet computer, a laptop computer, a medical device, industrial equipment, a sensor, an entertainment device, and/or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and system 100 may be configured to provide ultra-reliable communications for these functions.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130). The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to a network operator's IP services. Operator IP services may include access to the Internet, Intranet(s), an IP Multimedia Subsystem (IMS), or a Packet-Switched (PS) Streaming Service.

System 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz. System 100 may also operate in an extremely high frequency (EHF) region of the spectrum (e.g., from 30 GHz to 300 GHz), also known as the millimeter band. In some examples, system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some examples, base station 105 or UE 115 may be equipped with multiple antennas, which may be used to employ techniques such as transmit diversity, receive diversity, MIMO communications, or beamforming. For example, system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g., synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based on listening according to different receive beam directions (e.g., a beam direction determined to have a highest signal strength, highest signal-to-noise ratio, or otherwise acceptable signal quality based on listening according to multiple beam directions).

Base station 105 may transmit a control channel, such as a physical downlink control channel (PDCCH), in order to convey downlink control information (DCI) to UE 115. The DCI can be UE-specific (dedicated) or cell-specific (common) and placed in different dedicated and common search spaces within the PDCCH. A single PDCCH may carry DCI associated with multiple UEs 115. A particular UE 115, therefore, may need to be able to recognize the its DCI in the PDCCH. To that end, a UE 115 may be assigned one or more UE-specific search spaces in the control channel, and may also utilize common search spaces allocated to the UE 115 as well as other UEs 115 in the system 100. The UE 115 may attempt to decode the DCI by performing a process known as blind decoding, during which multiple decoding attempts are carried out in the search spaces until a DCI message is detected or all of the decoding candidates have been checked. Additionally, or alternatively, group-based DCI may be utilized in the PDCCH as described herein. In some aspects, UEs 115 may separately receive an indicator of the group-based DCI which may indicate a location of the G-DCI message in the PDCCH, a size of the G-DCI message, scheduling information for different control groups of the G-DCI message, etc.

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, system 100 may be a packet-based network that operates according to a layered protocol stack. A given layer in the protocol stack may accept a service data unit (SDU) from an upper layer, perform layer-specific processing, and deliver a protocol data unit (PDU) to a lower layer. In the user plane, communications at the bearer or PDCP layer may be IP-based. The PDCP layer may support use of a message authentication code for integrity (MAC-I) which may be configured for one or more logical channels on which a UE communicates. An RLC layer may in some cases perform error correction through packet ARQ, such as for acknowledged mode (AM) transmissions, as well as segmentation and reassembly for communicating over logical channels. RLC PDUs may include segmentation information in an RLC header. The segmentation information can provide an explicit indication that, for a particular RLC SDU, a corresponding RLC PDU comprises either all bytes of the RLC SDU, the first (starting) segment of the RLC SDU, the last (ending) segment of the RLC SDU, or neither the first nor the last segment of the RLC SDU. The RLC layer may also use the segmentation information and sequence numbers (SNs) to reorder packets and segments received from lower layers.

A Medium Access Control (MAC) layer may perform priority handling and multiplexing of logical channels into transport channels. The MAC layer may multiplex a plurality of MAC subPDUs to form a MAC PDU (transport block) and may inform the RLC layer of a payload size for purposes of segmentation. Each MAC subPDU may comprise a MAC subheader and a MAC SDU (RLC PDU). In general, the MAC layer operates to avoid non-consecutive RLC PDUs in a transport block (MAC PDU) when the UE generates more than one. The MAC layer may also support hybrid automatic repeat request (HARQ) to provide retransmission at the MAC layer to improve link efficiency. In the control plane, the RRC protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as OFDM or DFT-s-OFDM).

The organizational structure of the carriers may be different for different radio access technologies (e.g., LTE, LTE-A, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers. A carrier may be associated with a particular bandwidth of the radio frequency spectrum, and in some examples the carrier bandwidth may be referred to as a “system bandwidth” of the carrier or the system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

System 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers. In some cases, system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable. Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

System 100 may include one or more UEs 115 having a communication manager 101. Communication manager 101 may identify a plurality of packets for transmission to a receiver and identify those for which an integrity protection code is to be generated. For packets which require an integrity protection code, communication manager 101 may determine whether the packets have been segmented by upper layer processing. If the packets have been segmented, communication manager 101 may identify a start and end segment and may place the segments in different transport blocks of a same or different logical channel in a same or different time slot. In some examples, the communication manager 101 may place the segments out-of-order with respect to the protocol data unit sequence numbers of other packets of a same or different logical channel.

In some examples, communication manager 101 may place a start segment for a packet at or near an end of a first MAC subPDU of a first MAC transport block. This placement of the start segment may follow other packets having smaller protocol data unit sequence numbers. Communication manager 101 may place an end segment for the packet in a different transport block in order to reduce delays caused by computing the integrity protection code for an end packet while computing earlier packets during the assembly of the respective transport blocks. Communication manager 101 may place the end segment of the packet at the beginning of another transport block in a different time slot and the end segment may precede other packets having smaller protocol data unit sequence numbers. Alternatively, communication manager 101 may place the end segment of the packet at the end of another transport block in the same time slot. In another alternative, communication manager 101 may place the end segment of the packet at the beginning of another transport block in a different logical channel.

In another aspect, communication manager 101 may place a start segment for a packet at or near a first MAC subPDU of a first transport block. This placement of the starting segment in the first transport block may precede other packets having smaller protocol data unit sequence numbers. With a streaming approach to transport block assembly, placement of the starting segment in the transport block may correspond to transmission on a first symbol in a resource allocation of the UE 115. The end segment of the packet may also be placed out-of-order with respect to the protocol data unit sequence numbers of other packets of a same logical channel. In one aspect, communication manager 101 places the end segment in a transport block such that it follows other packets of the same logical channel which have larger protocol sequence numbers.

By creating separation in time and controlling placement of the segments, communication manager 101 may reduce or avoid delay due to the computation of the integrity protection code in the assembly of the respective transport blocks. These techniques may also potentially reduce device hardware requirements and cost. Among other aspects, these techniques can be used advantageously with carrier aggregation and in mixed service type scenarios in which high priority transmissions may interrupt or preempt lower priority services.

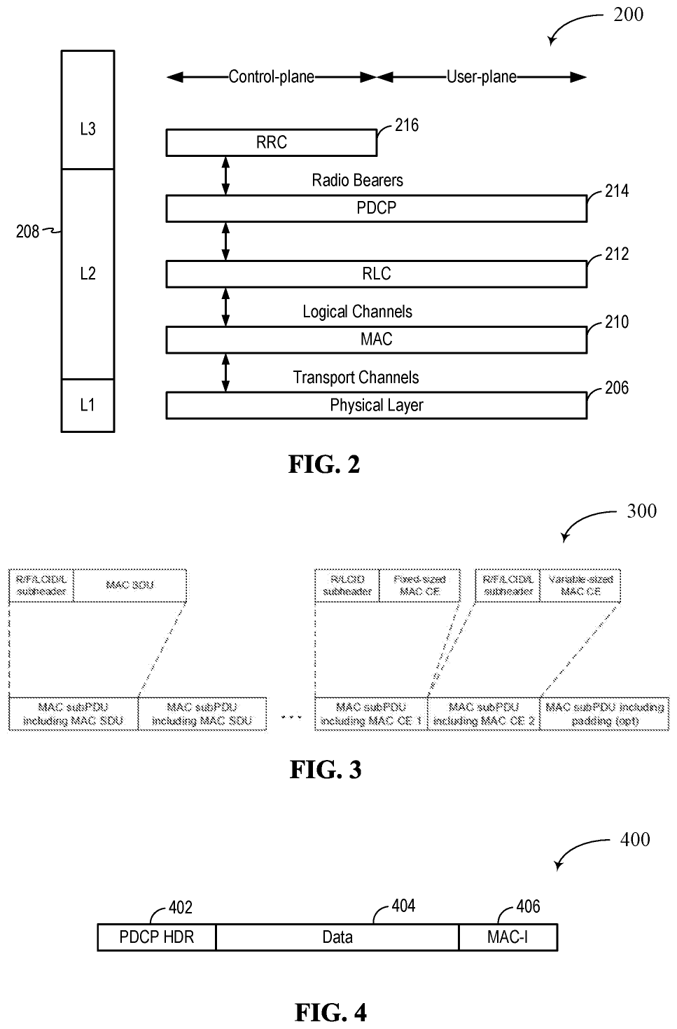

FIG. 2 shows an exemplary radio protocol architecture 200 aspects of which may be implemented by a UE and a base station as described herein. Exemplary radio protocol architecture 200 is shown with three layers: Layer 1, Layer 2, and Layer 3. Layer 1 is the lowest layer and implements various physical layer signal processing functions. Layer 1 will be referred to herein as the physical (PHY) layer 206. Layer 2 (L2 layer) 208 is above the PHY layer 206 and is responsible for the link between a UE and a base station over the physical layer 206. Layer 3 is above Layer 2 and includes the RRC layer 216.

In the control plane, RRC layer 216 may provide for establishment, configuration, and maintenance of an RRC connection between a UE and a base station. In the user plane, the L2 layer 208 may include a media access control (MAC) sublayer 210, a RLC sublayer 212, and a PDCP 214 sublayer, which protocols are terminated at the base station on the network side. Although not shown, the UE may have several upper layers above the L2 layer 208 including a network layer (e.g., IP layer) that is terminated at a PDN gateway on the network side, and an application layer that is terminated at the other end of the connection (e.g., far end UE, server, etc.).

The PDCP sublayer 214 provides transfer of user plane or control plane data, maintenance of PDCP sequence numbers, header compression for upper layer data packets to reduce radio transmission overhead, security by ciphering the data packets, and handover support for UEs between base stations. PDCP sublayer 214 may also implement an integrity protection function for packets. If configured, packets of a logical channel may be integrity protected before ciphering. In one aspect, the UE computes a Message Authentication Code for Integrity (MAC-I) for a packet and includes it with the packet at transmission. The receiver separately calculates the MAC-I value and compares it to the received value. If the calculated MAC-I matches the received MAC-I, then the integrity of the packet is successfully verified.

RLC sublayer 212 may provide segmentation and reassembly of upper layer data packets, retransmission of lost data packets, and reordering of data packets to compensate for out-of-order reception due to hybrid automatic repeat request (HARQ). When building packets, RLC sublayer 212 may add segmentation information to indicate that a packet contains all bytes of an RLC SDU, a first segment of the RLC SDU, a last segment of the RLC SDU, or neither the first nor the last segment of the RLC SDU. For instance, segmentation information may be included in a packet header to facilitate packet reassembly at the receiver. Segment sizes may be determined by notifications from MAC sublayer 210.

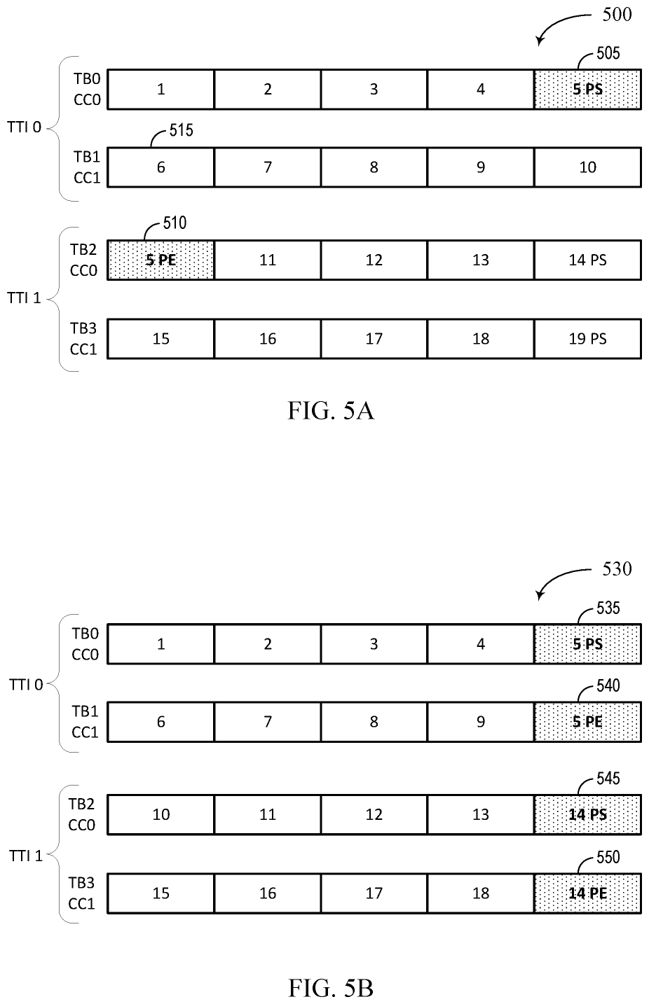

The MAC sublayer 210 provides multiplexing between logical and transport channels and is responsible for HARQ operations. In one aspect, shown in FIG. 3, MAC sublayer 210 generates transport blocks 300 for transmission on an uplink shared channel. Each transport block may include an arrangement of one or more MAC subPDUs. Each MAC subPDU, in turn, may include a MAC subheader and one of a MAC SDU, a MAC CE, or padding. As shown, transport blocks 300 generated by MAC sublayer 210 may include a plurality of variable-sized MAC SDUs (RLC PDUs) belonging to different logical channels.

According to the present disclosure, MAC sublayer 210 may be configured to arrange MAC subPDUs into one or more transport blocks 300 for uplink transmission based at least in part on a logical channel configuration of the corresponding MAC SDUs, a segmentation of the MAC SDUs, an uplink transmission timing requirement, a number of transport blocks to be processed concurrently, a resource allocation associated with an uplink grant, a service type, formatting requirements, or any combination thereof. For instance, in one aspect, a single MAC entity of MAC sublayer 210 may support multiple PHY layer 206 entities when the UE is configured for carrier-aggregation. Based on a grant of uplink resources, the MAC entity may assemble a plurality of transport blocks 300 for concurrent uplink transmission on a respective plurality of component carriers. The UE may need to transmit each of the transport blocks 300 on its assigned resources within a specified time from receipt of the uplink grant. In that case, the MAC entity may build the transport blocks 300 for the different component carriers in a parallel fashion and may avoid dependencies between transport blocks arising from computing MAC-I by placing the MAC SDUs into the transport blocks 300 as described herein.

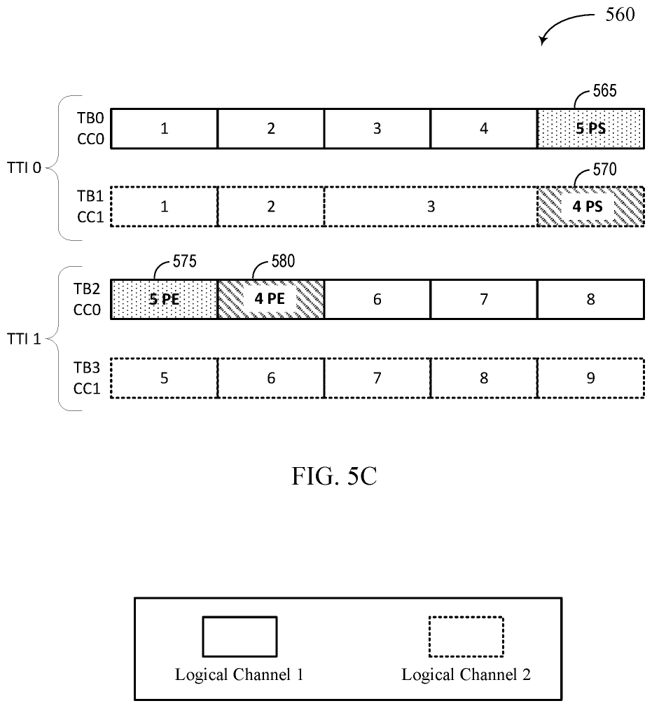

FIG. 4 shows an example PDCP data PDU structure 400 in accordance with the present disclosure. The PDCP data PDU structure 400 may be an RRC PDCP. The PDCP data PDU structure 400 may be MAC SDUs (RLC PDUs), and each placement in a transport block (TB0 through TB3) may correspond to a MAC subPDU as discussed herein. A communication manager such as the communication managers discussed in FIGS. 1 and 7-9 may generate or decode the PDCP data PDU structure 400.

The PDCP data PDU structure 400 may be a data packet and may include a PDCP header 402, a data portion 404, and a MAC-I 406. The PDCP header 402 may include header information for the packet. The data portion 404 may contain the data for the packet, which may be broken into different sequence numbers. The MAC-I 406 may include the DBR IP information.

Because data bearer integrity protection may be optional at the RRC layer in NR, the MAC-I 406 may be a value calculated on the PDCP header 402 and the data portion 404 when integrity protection is enabled and a null value when integrity protection is not enabled. When integrity protection is enabled, the MAC-I may be calculated for a given PDCP PDU packet using an integrity protection algorithm. Techniques described herein may use a 128-bit key that supports 128-bit NR integrity algorithms (NIA): 128-NIA0, 128-NIA1, 128-NIA2, and 128-NIA3. In some examples, the 128-NIA keys may be identical to 128-EIA keys as used in LTE.

NIA0 is a null integrity protection algorithm that may be used when integrity protection is disabled. Any MAC-I 406 generated with NIA0 will be 0. Even when NIA0 is used, Os will be appended onto the end of the PDCP PDU for the length of the MAC-I portion 406. In some examples, when NIA0 is used, the MAC-I portion 406 includes 32 zeros. When integrity protection is enabled, NIA1, NIA2, or NIA3 may be used to calculate MAC-I 406, for example. NIA1 may be a 128-bit SNOW 3G based algorithm, NIA2 may be a 128-but AES based algorithm, and NIA3 may be a ZUC based algorithm. In other examples, other algorithms may be used.

Inputs to the IP algorithm used may include a 128-bit integrity key, a 32-bit count, a 5-bit bearer identity, a 1-bit direction, and the message. The 128-bit integrity key may be generated by the network and based on the supported NIA0, NIA1, NIA2, and NIA3. The 32-bit count may be a sum of the hyperframe number (HFN) and the sequence number for the PDCP data PDU. The 5-bit bearer identity may be an identity of the radio bearer and may be called BEARER (RB Id-1). The 1-bit direction may indicate whether the PDCP data PDU is sent over uplink (UL) or downlink (DL) (e.g., 0 for uplink and 1 for downlink). The message may be the header and data portions of the PDCP data PDU. The output of the IP algorithm is the 32-bit MAC-I 406, which is appended to the PDCP data PDU.

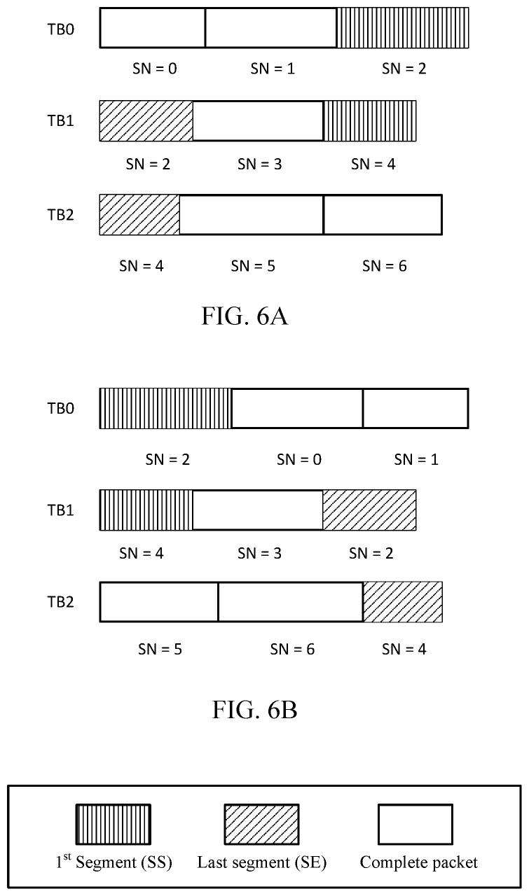

When integrity protection is used, the MAC-I 406 is generated before the PDCP PDU is transmitted. In the transmit path, the MAC-I 406 may be a 32-bit value computed using an integrity protection algorithm based on the PDCP header 402 and the data portion 404. After computation, the MAC-I 406 may be appended to the end of the PDCP data PDU structure 400. The PDCP data PDU structure 400 may be built into a TB, such as shown in FIGS. 5A-5C and transmitted.

A recipient of the PDCP PDU may have to decode the MAC-I 406 to confirm that the PDCP PDU is from the intended sender. The receive path may functionally be the reverse of the transmit path. In the receive path, the receiver calculates an XMAC-I which it compares to the MAC-I to validate the PDCP PDU. The XMAC-I is a 32-bit value that is computed based on the IP algorithm applied to the received PDCP PDU (i.e., PDCP header 402 and data portion 404). The PDCP PDU is validated by comparing the XMAC-I to the MAC-I 406. When there is a match, the PDCP PDU is validated. If the XMAC-I does not match the MAC-I 406, the receiver determines that the PDCP PDU is incorrect. For example, if a UE receives an RRC connection setup message, the UE may use the header and data portions of the message to compute the XMAC-I. The UE compares the XMAC-I to the MAC-I in the message. If the message actually came from the network, the XMAC-I should match the MAC-I. However, if the message is coming from a man-in-the-middle or other attacker, who relayed the message after a delay, the XMAC-I will not match the MAC-I.

FIGS. 5A-5C show aspects of transport block assembly for uplink transmission in accordance with aspects of the present disclosure. The packets may be MAC SDUs (RLC PDUs) and each placement in a transport block (TB0 through TB3) may correspond to a MAC subPDU as discussed in connection with FIG. 4. The SNs may be generated by RLC sublayer 212 and may support DRB IP operations. As shown, some packets are complete packets and some have been segmented by RLC protocol sublayer 212. Segments are identified in the figures as partial start (PS) segments or partial end (PE) segments. This identification may, for example, be conveyed explicitly by segmentation information in a packet header or it may be implicitly indicated.

There may be several challenges for building the PDCP data PDU with the MAC-I due to restrictions on the UE regarding PDCP data PDU format, order of SNs, timing requirements, segmentation, maximizing data transmission, use of padding, and the like. It may be difficult to meet these requirements in the short time duration provided.

For each packet, the MAC-I may be computed using the header and data portions of the PDCP data PDU, before ciphering is applied. In examples where two CCs are configured and for a packet N (N may be an integer), the transmitter may be expected to send two MAC TBs with PDCP SN N as a partial start at the end of a MAC TB0 and a SN N as a partial end at the beginning of the next TB, MAC TB1. The data may be expected to be pushed to the hardware at the symbol level. However, the timelines may be very short between the DL grant and the UL transmission, so not all of the data may be sent at once. As MAC-I is on the complete PDU, to send the SN N partial end along with the MAC-I, SN N may need to be processed from the first byte as part of MAC TB1.

This means that the entire PDU SN N packet would need to be processed at the beginning of the first slot of MAC TB1, even though only the very last part of the SN 5 packet goes in TB1. This becomes challenging under certain conditions, such as when the size of the PDU is large (e.g., such as up to a maximum supported size of 9000 bytes) and the timeline is short. Furthermore, the network may indicate in the UL grant which of the configured time domain allocations the UE shall apply for that UL grant. The UE may determine a bit width of the DCI field based on the number of entries in a PUSCH-TimeDomainResourceAllocationList. An integer, K2, may indicate a time between the reception of the UL grant and the encoding time. K2 may be a configurable value from 0 to 32, for example. The network may determine K2. In NR, with K0, K1, K2, etc. variable values, in some configurations, the UE may have to send the PDCP data PDU in a same frame or same slot as the UL grant is received. In some examples, there may be no time between the UL grant and the encoding time. In some examples where the UE decodes the UL grant in a first slot, the UE must send the PDCP data PDU in the next grant slot. These strict timelines provides little time for computation and building of the PDCP data PDU, as, for example, an entire slot may be 125 μs.

In some examples, each RLC SDU may be used to construct an RLC PDU without waiting for notification from a lower layer (i.e., by MAC) of a transmission opportunity. In the case of acknowledged mode or unacknowledged mode RLC entities, an RLC SDU may be segmented and transported using two or more RLC PDUs based on one or more notifications from the lower layer. RLC PDUs may be submitted to the lower layer only when a transmission opportunity has been notified by the lower layer (i.e., by MAC).

In some examples, the UE should aim to prevent excessive non-consecutive RLC PDUs in a MAC PDU when the UE is requested to generate more than one MAC PDU. However, some examples may have sequence numbering out of order within one TB or across TBs in a same TTI.

For building PDUs and during scheduling procedures, a UE may conform to one or more rules. First, the UE shall not segment an RLC SDU (or partially transmitted SDU or retransmitted RLC PDU) if the whole SDU (or partially transmitted SDU or retransmitted RLC PDU) fits into the remaining resources of the associated MAC entity. Second, if the UE segments an RLC SDU from the logical channel, it shall maximize the size of the segment to fill the grant of the associated MAC entity as much as possible. Third, the UE should maximize the transmission of data. Fourth, if the MAC entity is given an UL grant size that is equal to or larger than 8 bytes while having data available and allowed for transmission, the MAC entity shall not transmit only padding BSR and/or padding.

The examples shown in FIGS. 5A-5C provide some example transport block assemblies for uplink transmissions that comply with the above-described rules and meet the timing and format requirements.

FIG. 5A shows an arrangement of packets SN1-SN19 in example transport blocks TB0, TB1, TB2, and TB3. MAC transport blocks TB0 and TB1 are part of a first TTI, TTI 0, and MAC transport blocks TB2 and TB3 are part of a second TTI, TTI 1. In this example, two component carriers are configured in the uplink, CC0 and CC1. In every TTI, a single MAC entity may transmit two MAC transport blocks, each on one of the CCs.

TB0 may be on a first component carrier, CC0, and TB1 may be on a second component carrier, CC1. TB2 may be on CC0 and TB3 may be on CC1. In this arrangement, most of the packets are placed into respective transport blocks according to their SN numbers. As can be seen, the packets are ordered consecutively from SN=1 to SN=19, starting with a first location in TB0 and ending with a last location in TB3. In one aspect, the locations for placement of the packets may be MAC subPDUs as shown in FIG. 3, or a subset thereof.

In the example of FIG. 5A, two CCs are configured, so the UE is expected to send two MAC TBs with PDCP SN 5 partial start at the end of TB0 and SN 5 partial end at the beginning of TB. When the UE is to send two MAC TBs, from SN 1 to SN 9, the UE may send 1 to 4.5 on one TB and 4.5 to 9 on the next TB, so that all the packets are in sequence and organized according to the applicable standard. In the next TTI, the UE may send SN 10 to 14.5, then 14.5 to 18. SN 14 may need to be segmented into TB2. According to techniques described herein, any segmented packet present in a TB may be given priority in ordering over unsegmented packets.

It can be seen that some partial start segments may appear in the last location of one transport block while their corresponding partial end segments extends into the first location of the next transport block. For example, the first segment of packet SN 5, partial start 505, may be placed in the last location of TB0 while the last segment of packet SN 5, partial end 510, may occupy the first location of TB2. As MAC-I is on the complete PDU, in order to send the SN 5 partial end along with the MAC-I, SN 5 needs to be processed from its first byte as part of MAC TB1. In other words, because the UE sends CC0 and CC1 simultaneously, it needs to process SN 1 and SN 5 at the same time. That is, the whole process of determining MAC-I for SN 5 must be completed while SN1 is processed.

In examples where there is no integrity protection being used, if TB0 can only carry four and a half PDUs, the UE would start processing TB1 from the partial end of SN 5. However, when integrity protection is enabled, MAC-I must be calculated, which needs all the bytes in order to be calculated. Techniques described herein encode the first SN of a MAC TB and the entire PDU of a partial end SN of the MAC TB. The MAC-I is calculated, appended to the end of the PDU, and then the partial end of the segmented SN is transmitted.

As a numerical example, consider that each transport block has a length of 450 bytes and the packets are 100 bytes. When integrity protection is disabled, there is no MAC-I, so the UE knows that the first 450 bytes of the PDUs in sequence number order may be included in the TB0 of CC0. The TB1 on CC1 can start from byte 451, and the SN 5 partial end would be bytes 451-500. Without using integrity protection, the UE may process bytes 1-100 and 451-500 as it starts to build TB0 and TB1, without processing bytes 401-450 of the SN 5 partial start. The UE may continue to process SN 2 and SN 6, then SN 3 and SN 7, and so on. However, with integrity protection enabled, the UE processes bytes 401-450 of the SN 5 partial start while also processing bytes 1-100 and 451-500. Techniques described herein provide ways to generate the MAC TBs there may be little to no time between the UL grant and the encoding time. The disclosed techniques can mitigate these issues by creating separation from a transmission timing perspective between starting segments and end segments of a packet for which the UE computes an integrity protection code.

As shown in FIG. 5A, TB0 and TB1 of TTI 0 are calculated before TB2 and TB3 of TTI 1. By moving SN 5 PE to 510, which is the beginning of TB2, instead of 515, which is the beginning of TB1, the UE does not have to calculate all of SN 5 while it is also processing SN 1 and the SN 5 PE. In this example, the UE may calculate SN 1 and SN 6, then SN 2 and SN 4, then SN 3 and SN 8, then SN 4 and SN 9, and then SN 5 and SN 10. The UE may then truncate SN 5 when building TB0. The UE may send TB0 and TB1 simultaneously. When the UE moves to TTI 1, the SN 5 is already calculated, so the UE builds TB2 with the SN 5 partial end and then SN 11 through SN 14 partial start. The UE may simultaneously build TB3 with SN 15 through SN 19 partial start. The sequence may continue for additional TTIs.

FIG. 5B shows an arrangement of packets SN 1-SN 18 in example transport blocks TB0, TB1, TB2, and TB3 over TTI 0 and TTI 1 as described in FIG. 5A. However, in this example, the partial starts and partial ends of the same SNs (e.g., SN 5 and SN 14) are sent on the same time slot. SN 5 partial start is at 535 and its corresponding partial end is at 540. This way, the UE does not need to process SN 5 while processing 1-4 and 6-9. Likewise, SN 14 partial start is at 545 and its corresponding partial end is at 550. This alternative maintains full compliance with the rules and the sequence numbers are only a little out of order. Thus, whenever there is a partial PDU for a given PDU SN for one TB in a given TTI, the remaining part of the PDU SN can be optionally transmitted in the same TTI as the last PDU in the other TB, if available. According to techniques described herein, any segmented packet present in a TB may be given priority in ordering over unsegmented packets.

FIG. 5C shows an arrangement of packets SN 1-SN 9 in example transport blocks TB0, TB1, TB2, and TB3 over TTI 0 and TTI 1 as described in FIG. 5A. However, in this example, there are two logical channels. A first logical channel is represented by solid lines and includes TB0 and TB2. A second logical channel is represented by dashed lines and includes TB1 and TB3.

In this example, TB0 includes SN 1-SN 4 and SN 5 partial start 565, in the first logical channel. TB1 includes SN 1-SN 3 and SN 4 partial start 570 in the second logical channel. TB0 and TB1 are sent in the TTI 0. TTI 1 includes TB2 and TB3. TB2 includes SN 5 partial end 575 and SN 4 partial end 580 as well as SN 6-SN 8 in the first logical channel. TB3 includes SN 5-SN 9 in the second logical channel. As part of TTI 1, the partials are prioritized first across the first logical channel, before sending the complete PDUs per each logical channel. This example may include transmitting all of the partials across the first logical channel (LC0) and the second logical channel (LC1), before encoding the LC0 specific complete PDUs fully.

Using these alternatives described in FIGS. 5A-5C, the UE can send a remaining portion of a partial PDU in a next time slot instead of in the same time slot as the first portion of the partial PDU. Whenever there is a partial PDU for a given SN in one TB in a TTI, the remaining portion of the SN can be transmitted in the next TTI. With this mechanism, the UE can encode the first part of the PDU at that SN, store the context, and continue the PDU as part of the next TTI. These techniques also follow the rules of mostly maintaining sequence order, continuing the segmentation, maximizing the MAC TB, and not using MAC padding when unneeded.

In other examples, other numbers of TTIs, TBs, SNs, and CCs may be used. Additionally, even though the examples described in FIGS. 5A-5C are directed to a carrier aggregation cases, the techniques described herein may apply to MIMO cases where multiple MAC TBs are generated out of a single MAC entity on the same component carrier.

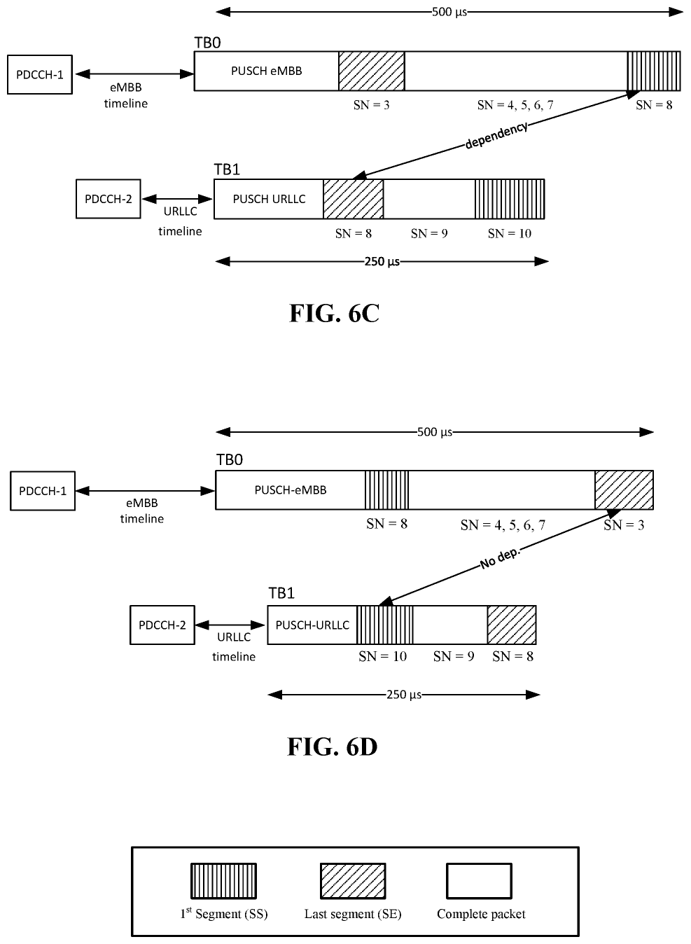

FIGS. 6A-6D show aspects of transport block assembly for uplink transmission in accordance with aspects of the present disclosure. FIGS. 6A-6D show transport blocks with packets arranged for uplink transmission. The packets may be MAC SDUs (RLC PDUs) and each placement in a transport block (TB0 through TB1) may correspond to a MAC subPDU as discussed in connection with FIG. 3. The SNs may be generated by RLC sublayer 212 and may support either acknowledged mode or unacknowledged mode operation. As shown, some packets are complete packets and some have been segmented by RLC protocol sublayer 212. Segments are identified in the figures as first (starting, SS) segments or last (ending, SE) segments. This identification may, for example, be conveyed explicitly by segmentation information in a packet header or it may be implicitly indicated.

FIG. 6A shows a baseline arrangement of packets SN1-SN6 in exemplary transport blocks TB0, TB1, and TB2. In this arrangement, the packets are placed into respective transport blocks according to their SN numbers. As can be seen, the packets are ordered consecutively from SN=0 to SN=6 starting with a first location in TB0 and ending with a last location in TB2. In one aspect, the locations for placement of the packets may be MAC subPDUs as shown in FIG. 3, or a subset thereof. It can be seen that some starting segments may appear in the last location of one transport block with their corresponding end segments extending into the first location of the next transport block. For example, as shown, the first segment of packet SN=2 may be placed in the last location of TB0 and the last segment of packet SN=2 may occupy the first location of TB1, etc.

While the baseline arrangement of FIG. 6A does avoid placement of non-consecutive RLC PDUs, when integrity protection is enabled it may create unnecessary dependencies between the transport blocks which can thwart parallel processing and impact transmission timelines. For instance, the UE may compute a MAC-I for packet SN=2 in a running fashion by fetching portions of the packet from memory and generating the integrity protection code. Due to the packet segmentation, the UE may not be able to place the end segment of packet SN=2 in TB1, which includes the MAC-I covering the whole packet, until it has first performed integrity protection on the SN=2 starting segment. Since the starting segment of packet SN=2 occupies a last location in TB0, assembly of TB1 may be delayed until processing of TB0 is complete as the integrity protection code is computed over the entire SN=2 packet. Thus, the end segment of packet SN=2 in TB1 depends on the starting segment of packet SN=2 in TB0 which, in turn, occupies the last TB location. A similar issue may be encountered with packet SN=4 and other packets in a segmented TB build. The effect of this baseline placement may thus be to require sequential processing of transport blocks which may not be suited for low latency operation, strict transmission timelines, and the like.

FIG. 6B shows a modified arrangement of packets SN=0 to SN=6 in the three exemplary transport blocks according to the present disclosure. In the arrangement of FIG. 6B, consecutive placement of packets according to RLC SN may be modified when integrity protection is enabled. In general, when more than one TB is assembled, the UE may place an RLC PDU with SN=N and containing an end segment after an RLC PDU with SN>N of the same logical channel in a transport block. Similarly, during transport block assembly, the UE may place an RLC PDU with SN=M and containing a start segment before an RLC PDU of the same logical channel having SN<M. In this way, separation in time may be increased for segmented packets for which integrity protection is enabled.

In the example of FIG. 6B, a tail-head swap (THS) approach is illustrated which may maximize the separation in time between segments of a packet across transport blocks. As shown, relative to the arrangement of FIG. 6A, the starting segment of packet SN=2 in TB0 is moved to a first location in the transport block and full packets SN=0 and SN=1 are shifted to subsequent TB locations. Also, the end segment of packet SN=2 is moved to the last location in TB1. The separation in build and/or transmission time resulting from the arrangement of FIG. 6B can permit a pipelined or parallel processing of TB0 and TB1 that avoids dependencies which can arise through computation of the integrity protection code. A similar benefit is realized from the THS approach by swapping the position of the packet SN=4 segments in TB1 and TB2.

FIG. 6C depicts a baseline arrangement of packets SN=3 to SN=10 in exemplary transport blocks TB0 and TB1. In this example, TB0 is transmitted on a first component carrier with eMBB service and TB1 is transmitted on a second component carrier with URLLC service. Both transport blocks are to be sent on a PUSCH of their respective carriers. For the first component carrier, PDCCH-1 provides a grant of uplink shared channel resources that triggers assembly of TB0 on an associated eMBB transmission timeline. The exemplary duration of the TB0 transmission is 500 us. During this process, another uplink grant, PDCCH-2, is received triggering a URLLC PUSCH on the second component carrier with an exemplary 250 microsecond (μs) duration. Even though TB1 is triggered subsequent to TB0, it will be transmitted first in the present example as the PDCCH-to-PUSCH timing for URLLC is shorter than for the eMBB transmission. Moreover, as can be seen, the placement of the SN=8 start segment in the last location of TB0 may create a dependency that delays processing of TB1. This delay may not comply with URLLC service requirements and may cause packet SN=8 to be dropped or some other action to be taken thereby reducing the efficiency of uplink communications.

FIG. 6D shows a modified arrangement of packets SN=3 to SN=10 in the two exemplary transport blocks of FIG. 6C. In this exemplary arrangement, the placement of RLC PDUs in TB0 is altered to facilitate concurrent processing of the eMBB and URLLC transmissions. Assume that integrity protection is enabled for the logical channel and that packet segmentation is to be performed. While the eMBB transmission might seek to avoid a non-consecutive placement of RLC PDUs in a corresponding transport block, the URLLC grant may alter this behavior. In particular, as assembly of TB0 proceeds, the UE may detect a second grant of resources for the URLLC transmission and may modify the arrangement of RLC PDUs by placing the end segment of packet SN=3 in the last location of TB0 and the start segment of packet SN=8 into the first TB0 location. With this non-consecutive placement, the starting segment of packet SN=8 precedes packets SN=4, SN=5, SN=6, and SN=7 in TB0. Likewise, in TB0, the end segment of packet SN=3 follows packets with SN=8, SN=4, SN=5, SN=6, and SN=7. As illustrated, the starting segment of packet SN=10 is placed in the first location of TB1 and the end segment of packet SN=8 is placed in the last TB1 location. The cross-TB dependency of packet SN=8 in FIG. 6C is thereby avoided and the corresponding MAC-I computation may be completed without impacting the timing of TB1.

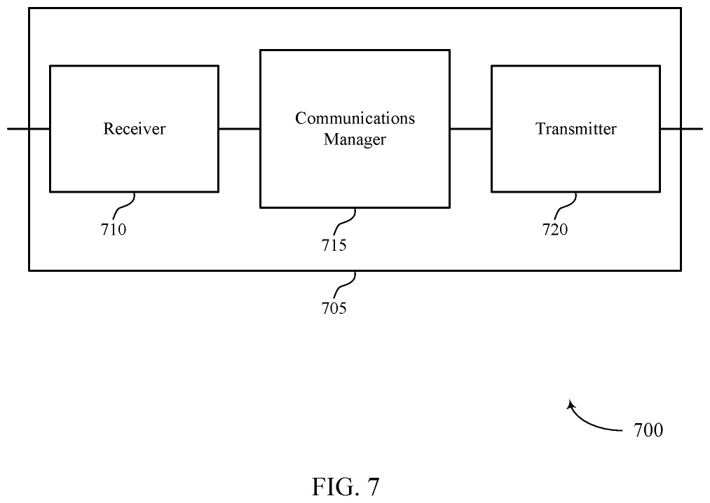

FIG. 7 shows a user equipment 705 which supports low latency transport block assembly according to the present disclosure. UE 705 may be an example of the UE 115 described with reference to FIG. 1 and may implement aspects of the radio protocol architecture of FIGS. 2-3 and the techniques for transport block assembly described in connection with FIGS. 5A-5C and 6A-6D. UE 705 may include a receiver 710, a communications manager 715, and a transmitter 720. UE 705 may also include a processor. Each of these components may be in communication with one another (e.g., via one or more buses).

Receiver 710 may be configured to receive information such as packets, user data, or control information associated with various information channels (e.g., control channels, data channels, system information, configuration messages, etc.). For example, under the control of communications manager 715, receiver 310 may receive slots or subframes having control information that schedules uplink transmissions on one or more component carriers or services channel of UE 705. Receiver 710 may pass such information on to other components of wireless device 705. For example, receiver 310 may pass information to communications manager 715.

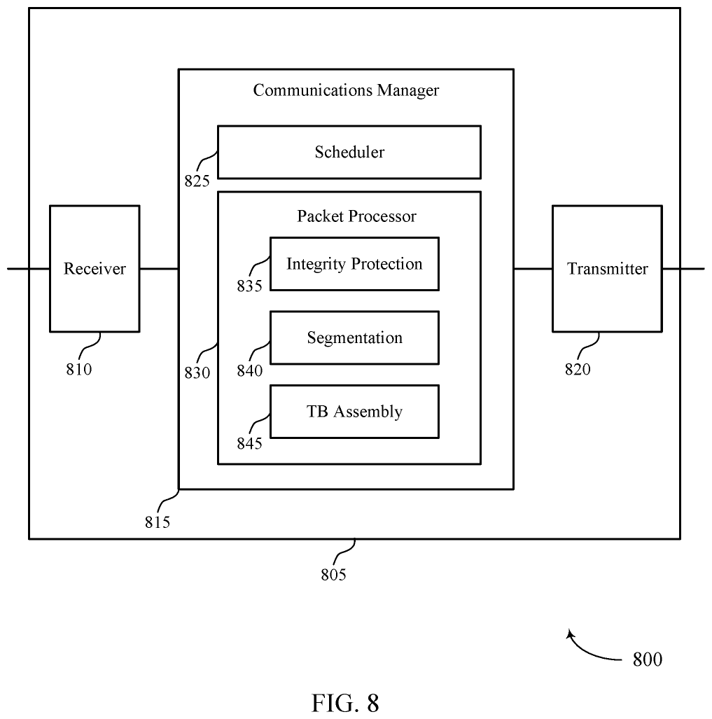

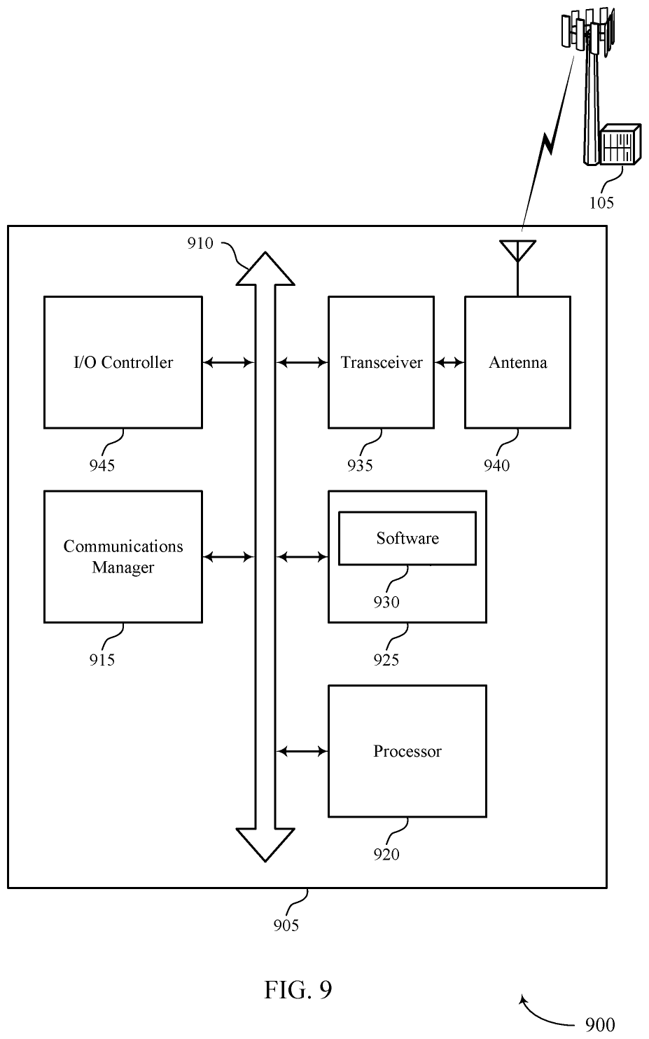

Receiver 710 may be an example of aspects of the transceiver 935 described with reference to FIG. 9. Communications manager 715 may be an example of aspects of the communications manager 815 described with reference to FIG. 8.

Communications manager 715 and/or at least some of its various sub-components may be implemented in hardware, software executed by a processor, firmware, or any combination thereof. If implemented in software executed by a processor, the functions of the communications manager 715 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. In some examples, communications manager 715 and/or at least some of its sub-components may be configured as a separate and distinct element in accordance with various aspects of the present disclosure. In other examples, communications manager 715 and/or at least some of its various sub-components may be combined with one or more other hardware components, including but not limited to an I/O component, a transceiver, one or more other components described in the present disclosure, or a combination thereof in accordance with various aspects of the present disclosure.

Communications manager 715 may identify RLC PDUs to send to a receiver. Each of the RLC PDUs may be associated with a corresponding logical channel and may have a sequence number generated by an RLC protocol entity of UE 705. Communications manager 715 may determine whether use of an integrity protection code is configured for a first logical channel. A plurality of RLC PDUs, including a first start segment and a first end segment, may be identified for a first logical channel. The first start segment and the first end segment may be portions of a first packet having a first SN in relation to other RLC PDUs of the first logical channel.

If it is determined by communications manager 715 that integrity protection is not enabled, or if all of the RLC PDUs can be placed into a same transport block, then communications manager 715 may assemble the transport block by placing the RLC PDUs in a consecutive order according to their corresponding SNs. Similarly, if communications manager 715 determines that a size of transport block can be filled with a single RLC PDU (perhaps with padding) according to a configuration of UE 705, then it may proceed to assemble the single-packet transport block and deliver it to transmitter 720.

When the identified RLC PDUs include segments, communications manager 715 may use a modified transport block assembly procedure in which temporal separation of start and end segments is provided in the arrangement. In one aspect, communications manager 715 may perform the transport block building procedures as discussed in connection with FIG. 5A to FIG. 5C to decrease additional simultaneous processing requirements. In another aspect, communications manager 715 may perform a tail-head swap procedure as discussed in connection with FIG. 6B or FIG. 6D to increase separation of the start and end segments.

Communication manager 715 may place an end segment for the packet in a different transport block in order to reduce delays caused by computing the integrity protection code for an end packet while computing earlier packets during the assembly of the respective transport blocks. Communication manager 715 may place the end segment of the packet at the beginning of another transport block in a different time slot and the end segment may precede other packets having smaller protocol data unit sequence numbers. Alternatively, communication manager 715 may place the end segment of the packet at the end of another transport block in the same time slot. In another alternative, communication manager 715 may place the end segment of the packet at the beginning of another transport block in a different logical channel.

Alternatively, communications manager 715 may be configured to place the first end segment having the first SN after a second RLC PDU of the first logical channel having a second SN that is larger than the first SN. Communications manager 715 may also be configured to place the first start segment having the first SN into a transport block before an RLC PDU of the same logical channel with an SN that is smaller than the first SN. After arranging the RLC PDUs in one or more transport blocks, communications manager 715 may them to transmitter 720.

Transmitter 720 may be configured to transmit signals generated by other components of UE 705. In one aspect, transmitter 720 may send transport blocks prepared by communications manager 715 to a receiver after physical layer processing. Transmitter 720 may be collocated with receiver 710 in a transceiver module. For example, the transmitter 720 may be an example of aspects of the transceiver 935 described with reference to FIG. 9. Transmitter 720 may include a single antenna, or it may include a set of antennas.

FIG. 8 shows a block diagram 800 of a user equipment 805 which supports low latency transport block assembly according the present disclosure. UE 805 may be an example of aspects of a UE 705 or a UE 115 as described with reference to FIGS. 1 and 5. UE 805 may also implement aspects of the protocol architecture and modified transport block assembly as discussed in connection with FIGS. 2-4. As shown, UE 805 includes a receiver 810, a communications manager 815, and a transmitter 820. UE 805 may also include a processor. Each of these components may be in communication with one another (e.g., via one or more buses).

Receiver 810 may be configured to receive information such as packets, user data, or control information associated with various information channels (e.g., control channels, data channels, etc.). In one aspect, receiver 810 is configured to receive signals on a plurality of component carriers in a carrier aggregation configuration of UE 805 and may support URLLC or other services with stringent transmission timelines. Receiver 810 may be configured to receive control information, including uplink grants, from a base station and to pass such information on to other components of UE 805. Receiver 810 may be an example of aspects of the transceiver 935 described with reference to FIG. 9.

Communications manager 815 may be an example of aspects of the communications managers 101, 715, or 915 described with reference to FIGS. 1, 7, and 9. As shown, communications manager 815 may include a scheduler 825 and a packet processor 830. Packet processor 830, in turn, may include an integrity protection component 835, a segmentation component 840, and a TB assembly component 845.

Scheduler 825 may be configured to manage uplink transmissions by UE 805. In one aspect, scheduler 825 identifies resources for uplink transmission and initiates the operation of packet processor 830. Uplink resources may be dynamically signaled in one or more uplink grants from a base station. The uplink grants may allocate resources on an uplink shared channel of one or more component carriers in a carrier aggregation configuration and may have an associated transmission timing requirement. For instance, receiver 810 may receive downlink control information comprising a grant of uplink resources and deliver it to scheduler 825. Scheduler 825 may identify that the uplink resources provide for transmission of two transport blocks on respective first and second carriers in a carrier aggregation configuration of UE 805 and that a transmission timing requirement is specified in relation to a slot in which the uplink grant(s) are received. Alternatively, or additionally, uplink resources may be allocated semi-statically and scheduler 825 may identify their availability based on a configuration of UE 805. Semi-persistent scheduling (SPS) or configured grants provide one example of semi-statically configured uplink resources. Uplink resources may also be semi-statically configured for URLLC service as one or more mini-slots which may overlap with uplink resources utilized with eMBB or other service types. Upon the arrival of high priority data, scheduler 825 may preempt an ongoing eMBB transmission on the shared channel and initiate URLLC packet processing operations.

When scheduler 825 determines the availability of uplink resources, it may initiate packet processing by indicating to packet processor 830 any or all of the dynamically allocated resources, the semi-statically configured resources, the number and/or size of transport blocks, the timing requirement for uplink transmission, the formatting requirements for the uplink transmission, or the service type associate with the uplink resources. Packet processor 830 may generate one or more transport blocks for uplink transmission. In some aspects, packet processor 830 may implement aspects of the radio protocol architecture discussed in connection with FIGS. 2-3 as previously discussed.

Packet processor 830 may obtain data for uplink transmission from a memory of UE 805. The data may be packetized and each packet may be associated with a logical channel. If integrity protection is configured for a logical channel, packet processor 830 may direct packets associated with the logical channel to the integrity protection component 835 to compute an integrity protection code. In some aspects, integrity protection component 835 computes a message authentication code for integrity (MAC-I). The MAC-I may be computed for each PDCP PDU of the logical channel, ciphered, and included with the uplink data transmission for use by the receiver. If integrity protection is not enabled for a logical channel, integrity protection component 835 may be idle for related packets.

As discussed herein, serial processing of packets into transport blocks could add an unacceptable latency to uplink transmissions by UE 805. Depending upon the factors indicated by scheduler 825, packet processor 830 may perform its functions in a parallel fashion. For instance, depending upon the service type, uplink transmission timing requirements, and/or the number of transport blocks to be processed concurrently, integrity protection component 835 may compute the integrity protection code on a running basis so that other operations of packet processor 830 can advance.

Segmentation component 840 may be configured to divide large packets into segments for placement in transport blocks. In one example, segmentation component 840 may implement aspects of the RLC protocol layer functionality described in connection with FIGS. 2-6D. At the RLC layer, segmentation component 840 may receive a stream of PDCP PDUs for processing. Each PDCP PDU may be associated with a logical channel. When notified of an uplink transmission opportunity, segmentation component 840 may generate RLC PDUs by segmenting the PDCP PDUs according a size of RLC PDUs to be delivered to the TB assembly component 845. Segmentation component 840 may add segmentation information to indicate whether a particular RLC PDU is an entire packet, a first (starting) segment, or a last (ending) segment. Segmentation component 840 may also generate a sequence number for the packets it processes. The SN may be incremented for each packet and segmentation component 840 may maintain different SNs for each logical channel. In some aspects, segmentation component 840 assigns the same SN to all RLC PDU segments corresponding to a particular PDCP PDU.

TB assembly component 845 may be configured to receive packets and segments from segmentation component 840 and to arrange them into transport blocks for delivery to transmitter 820. In one example, TB assembly component 845 may implement aspects of the MAC protocol layer functionality described in connection with FIGS. 2-6D and the packets received from segmentation component 840 may include RLC PDUs.

Based on information received from scheduler 825, TB assembly component 845 may determine a number and size of transport blocks for uplink transmission in one or more slots. As discussed previously, the number and size of the transport blocks may be based on a resource grant and may relate to transmissions on multiple component carriers in a carrier aggregation configuration and/or transmissions for different service types such as eMBB and URLLC. Each transport block may comprise a plurality of locations at which packets and segments may be placed during TB assembly. In some aspects, the transport block locations correspond to MAC subPDUs as shown in FIG. 3. In some aspects, the transport block locations may also correspond to OFDM symbol locations in an uplink resource allocation such that packets placed near the head of a TB may be transmitted before packets placed near the tail of the transport block. TB assembly component 845 may use temporal separation of symbols in a resource grant to coordinate the packet processing of integrity protection component 835 and segmentation component 840 as described herein.

In one aspect, TB assembly component 845 may identify RLC PDUs to send to a receiver. Each of the RLC PDUs may be associated with a logical channel and each may include a sequence number of the logical channel generated by an RLC protocol entity of the UE such as segmentation component 840. TB assembly component 845 may determine whether use of an integrity protection code is configured for a first logical channel having at least one segmented packet in the identified RLC PDUs. The segmented packet may include a start segment and an end segment associated with a packet having a first SN of the first logical channel.

TB assembly component 845 may place an end segment for the packet in a different transport block than the start segment for the packet. TB assembly component 845 may place the end segment of the packet at the beginning of another transport block in a different time slot and the end segment may precede other packets having smaller protocol data unit sequence numbers. Alternatively, TB assembly component 845 may place the end segment of the packet at the end of another transport block in the same time slot. In another alternative, TB assembly component 845 may place the end segment of the packet at the beginning of another transport block in a different logical channel.

In another set of examples, TB assembly component 845 may arrange, based on a result of the determining, a first set of the RLC PDUs received from segmentation component 840 in a first transport block such that the end segment is placed after a second RLC PDU of the first logical channel having a second SN that is larger than the first SN. Aspects of this non-consecutive placement may be as shown in FIG. 6B in which, for example, the end segment of packet SN=2 is placed in TB1 after packet SN=3 and after the starting segment of packet SN=4. Depending upon the number and size of the transport blocks to assemble, TB assembly component 845 may arrange a second set of RLC PDUs in the identified RLC PDUs in a second TB such that the start segment is placed before a third RLC PDU in the identified RLC PDUs having a third SN that is smaller than the first SN. For instance, as shown in FIG. 6B, the starting segment for packet SN=2 is placed in TB0 before either packet SN=1 or packet SN=0. When placement of packets is complete, TB assembly component 845 may deliver the transport block(s) to transmitter 820 for over-the-air transmission to a receiver such as a serving base station of UE 805.

As the number of transport blocks to send increases, the possibility of delay due to computation of integrity protection codes also increases. In some aspects of the present disclosure, the operation of integrity protection component 825, segmentation component 840, and TB assembly component 845 may overlap. For example, as information from scheduler 825 becomes available, TB assembly component 845 may notify segmentation component 840 of a transmission opportunity, including a total size of RLC PDUs needed. Segmentation component 840 may identify packets and perform segmentation as needed for the transmission opportunity. In a parallel operation, integrity protection component 835 may compute an integrity protection code for packets based on a corresponding logical channel configuration.

In some aspects, segmentation component 840 and/or integrity protection component 835 may inform TB assembly component 845 that the total size of packets includes at least some segments in relation to which a packet-level integrity protection code (such as a MAC-I) is being computed. TB assembly component 845 may perform a modified TB placement in which start segments of packets for which integrity protection is enabled are placed before other packets of a same logical channel having smaller SNs than the start segments. Similarly, end segments of integrity protected packets may be placed after other packets of the same logical channel having larger SNs than the end segments. This non-consecutive placement of RLC PDUs into one or more transports blocks can create a temporal spacing that may allow computation of integrity protection codes to be pipelined with other operations of the packet processor 830 thereby making more efficient use of UE 805 hardware.

TB assembly component 845 may switch between a consecutive placement and a modified placement of RLC PDUs based at least in part on a logical channel configuration of the packets to be sent, a segmentation of the packets, an uplink transmission timing requirement, a number of transport blocks to be processed concurrently, a resource allocation associated with an uplink grant, a service type associated with the uplink resources, or any combination thereof. For instance, in cases where integrity protection is not utilized with any of the packets in a transport block, if only a single transport block is to be assembled (and URLLC is not configured), and/or if a single packet will fill the entire transport block, then TB assembly component 845 may utilize a consecutive placement. However, when integrity protection is enabled, when there is segmentation of integrity protected packets, when eMBB transmissions may be preempted by URLLC on designated uplink resources, and/or when multiple transport blocks must be assembled concurrently subject to strict transmission timing requirements, TB assembly component 845 may instead utilize a modified placement as described herein. In some aspects, in a streaming mode of operation, the operation of packet processor 830 may be performed at the level of each OFDM symbol of an uplink resource allocation and temporal spacing may be achieved by placement of packets in different transport block locations corresponding to different symbol periods in the uplink transmission.

In one aspect, packet processor 830 may be configured to place packets associated with different logical channels in a same transport block using the modified transport block assembly procedures disclosed herein. For instance, assuming that packets for logical channel (LCID) N and logical channel N+1 are to be included in a same transport block, starting segments for logical channel N may precede other packets of the same logical channel having smaller SNs and end segments of logical channel N may follow other packets having larger SNs in the transport block amidst packets for logical channel N+1 without departing from the present disclosure. One possible placement of RLC PDUs could be as follows: a starting segment for packet SN=5 in LCID N, a staring segment for packet SN=23 in LCID N+1, complete packet(s) for LCID N, complete packet(s) for LCID N+1, an end segment for packet SN=5 in LCID N, and an end segment for packet SN=23 in LCID N+1. In each case, communications manager 815 may depart from a consecutive placement by front-loading start segments and back-loading end segments in transport blocks to create separation in time and by which to facilitate concurrent packet processing. In one aspect, where separation in time would not be possible even with a modified placement of RLC PDUs, communications manager 815 may forgo including a portion of the ending packet in the uplink communication. For example, if packet scheduler 825 detects that a portion of a TB N+1 has a significant dependency on a portion of TB N, the packet scheduler may forego including that portion in TB N+1 and instead add padding or another segment start. This could happen, for example, when a starting segment of a packet SN=P occupies substantially the entire space of TB N and placement of the end segment of SN=P in TB N+1 without overlap would not be possible. In this example, packet scheduler 825 may not include the end segment of packet SN=P in TB N+1 but may instead wait for another grant or another transport block to become available.

Transmitter 820 may be configured to transmit signals generated by other components of user equipment 805. In one aspect, transmitter 820 may be configured to send uplink communications to a base station, including transport blocks received from the TB assembly component 845 of packet processor 830. For instance, transmitter 820 may be configured to provide services associated with PHY layer operation as described in connection with FIG. 2 and to send transport blocks with consecutive or modified placements in accordance with an uplink transmission timing. In some aspects, transmitter 820 may be collocated with receiver 810 in a transceiver module. For example, transmitter 820 may form part of transceiver 935 as described with reference to FIG. 9. Transmitter 820 may include a single antenna, or it may include a set of antennas.

FIG. 9 shows a system 900 including a wireless device 905 that supports low latency uplink communication in accordance with various aspects of the present disclosure. Wireless device 905 may be an example of, or include the components of, a UE or wireless device as described above, e.g., with reference to FIGS. 1, 7, and 8. Wireless device 905 may include components for bi-directional voice and data communications including components for transmitting and receiving communications, including communications manager 915, processor 920, memory 925, software 930, transceiver 935, antenna 940, and I/O controller 945. These components may be in electronic communication via one or more busses (e.g., bus 910). Device 905 may communicate wirelessly with one or more base stations 105.

Processor 920 may include an intelligent hardware device, (e.g., a general-purpose processor, an application processor, a SNAPDRAGON®, a DSP, a CPU, a microcontroller, an ASIC, an FPGA, a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting low latency transport block assembly).

Memory 925 may include RAM and ROM. The memory 925 may store computer-readable, computer-executable software 930 including instructions that, when executed, cause the processor to perform various functions described herein. In some cases, the memory 925 may contain, among other things, a BIOS which may control basic hardware and/or software operation such as the interaction with peripheral components or devices.

Software 930 may include code to implement aspects of the present disclosure, including code to support data channel search space operation. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may form a communications interface of wireless device 905 and may be operative for bi-directional communication, via one or more antennas, wired, or wireless links as described above. For example, the transceiver 935 may represent a wireless transceiver and may communicate bi-directionally with another wireless transceiver. The transceiver 935 may also include an RF front end to process a baseband signal and provide its output to the antennas 940 for transmission, and to similarly process packets received from the antennas.

In some cases, the wireless device 905 may include a single antenna 940. However, in some cases the wireless device 905 may have more than one antenna 940, which may be capable of concurrently transmitting or receiving multiple wireless transmissions.

I/O controller 945 may manage input and output signals for device 905. I/O controller 545 may also manage peripherals not integrated into wireless device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system. In other cases, I/O controller 545 may represent or interact with a modem, a keyboard, a mouse, a touchscreen, or a similar device. In some cases, I/O controller 945 may be implemented as part of a processor. In some cases, a user may interact with wireless device 905 via I/O controller 545 or via other hardware components controlled by I/O controller 945.

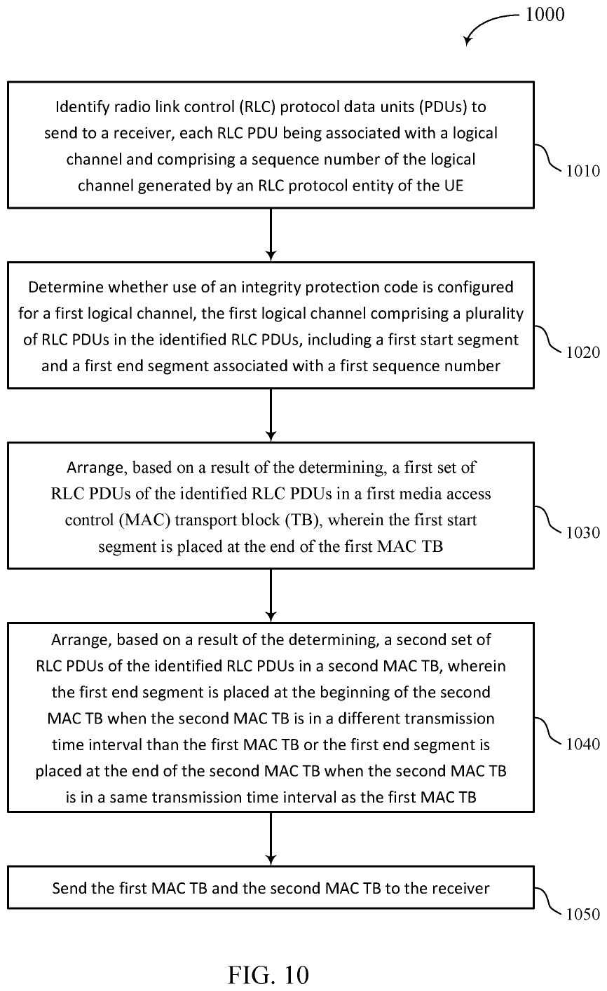

FIG. 10 shows a flowchart illustrating a method 1000 that supports DRB IP segmentation enhancements in accordance with aspects of the present disclosure. The operations of method 1000 may be implemented by UE 115, 705, 805, or a wireless device 905, or components thereof, as described herein. For example, the operations of method 1000 may be performed by a communications manager as described with reference to FIGS. 1 and 7-9. In some examples, a UE may execute a set of instructions to control the functional elements of the UE to perform the functions described below. Additionally or alternatively, a UE may perform aspects of the functions described below using special-purpose hardware.

At 1010, the UE may identify RLC PDUs to send to a receiver, each RLC PDU being associated with a logical channel and including a sequence number of the logical channel generated by an RLC protocol entity of the UE. The operations of 1010 may be performed according to the methods described herein. In some examples, aspects of the operations of 1010 may be performed by a communications manager as described with reference to FIGS. 1 and 7-9.

At 1020, the UE may determine whether use of an integrity protection code is configured for a first logical channel, the first logical channel including a set of RLC PDUs in the identified RLC PDUs, including a first start segment and a first end segment associated with a first sequence number. The operations of 1020 may be performed according to the methods described herein. In some examples, aspects of the operations of 1020 may be performed by a communications manager as described with reference to FIGS. 1 and 7-9.

At 1030, the UE may arrange, based on a result of the determining, a first set of RLC PDUs of the identified RLC PDUs in a first MAC TB, where the first start segment is placed at the end of the first MAC TB. The operations of 1030 may be performed according to the methods described herein. In some examples, aspects of the operations of 1030 may be performed by a communications manager as described with reference to FIGS. 1 and 7-9.

At 1040, the UE may arrange, based on a result of the determining, a second set of RLC PDUs of the identified RLC PDUs in a second MAC TB, where the first end segment is placed at the beginning of the second MAC TB when the second MAC TB is in a different transmission time interval than the first MAC TB or the first end segment is placed at the end of the second MAC TB when the second MAC TB is in a same transmission time interval as the first MAC TB. The operations of 1040 may be performed according to the methods described herein. In some examples, aspects of the operations of 1040 may be performed by a communications manager as described with reference to FIGS. 1 and 7-9.

At 1050, the UE may send the first MAC TB and the second MAC TB to the receiver. In some examples, sending the first MAC TB and the second MAC TB may include sending the first MAC TB on a first component carrier in a carrier aggregation configuration of the UE and sending the second MAC TB on the first component carrier in the carrier aggregation configuration of the UE. In another example, sending the first MAC TB and the second MAC TB may include sending the first MAC TB on a first component carrier in a carrier aggregation configuration of the UE and sending the second MAC TB on a second component carrier in the carrier aggregation configuration of the UE. In another example, sending the first MAC TB and the second MAC TB may include sending the first MAC TB on first resources allocated by a first resource grant associated with a first service type and sending the second TB on second resources associated with a second service type which overlap, at least in part, with the first resources. The operations of 1050 may be performed according to the methods described herein. In some examples, aspects of the operations of 1050 may be performed by a communications manager as described with reference to FIGS. 1 and 7-9.

In some examples, the second MAC TB is in a different transmission time interval than the first MAC TB and the plurality of RLC PDUs is a first plurality of RLC PDUs. The method of wireless communication 1000 may include determining whether use of the integrity protection code is configured for a second logical channel, the second logical channel comprising a second plurality of RLC PDUs in the identified RLC PDUs, including a second start segment and a second end segment associated with a second sequence number. The method may also include arranging, based on a result of the determining whether use of the integrity protection code is configured for the second logical channel, the second end segment in the second MAC TB after the first end segment.

Some examples may include arranging, based on the result of the determining whether use of the integrity protection code is configured for the second logical channel, the second start segment in a third MAC TB, wherein the third MAC TB is in the second logical channel. Additional examples may include arranging the first set of RLC PDUs in a consecutive order of sequence numbers in the first TB when it is determined that use of the integrity protection code is not enabled for the first logical channel.

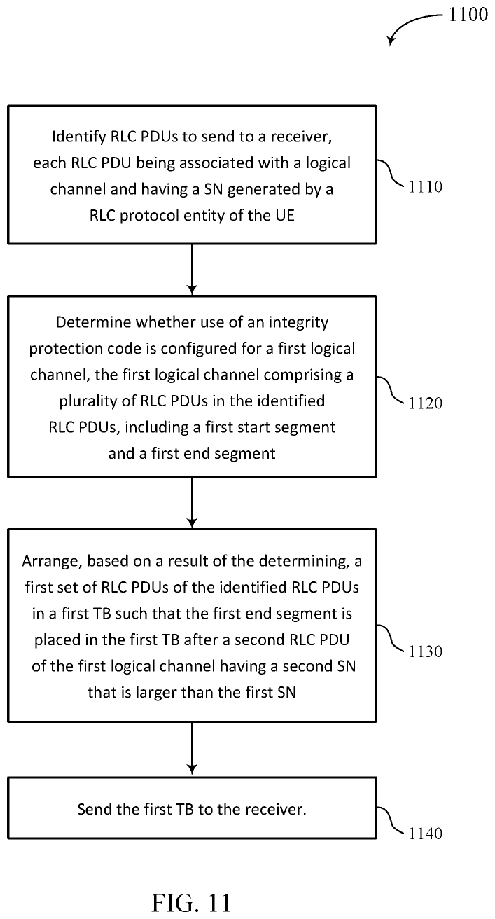

FIG. 11 shows a method of wireless communication 1100 in accordance with the present disclosure. The operations of method 1100 may be performed by a user equipment 115, 505, 605, or a wireless device 705, or components thereof. For example, the operations of method 1100 may be performed by a communications manager as described with reference to FIGS. 1 and 7-9. In some examples, a user equipment 115, 705, 805 or wireless device 905 may execute a set of codes to control the various elements of the device to perform the functions described below. Additionally or alternatively, the user equipment 115, 705, 805 or wireless device 905 may perform aspects of the functions described below using special-purpose hardware.

At block 1110, the user equipment may identify packets to send to a receiver such as a base station 105. Each packet may comprise an RLC PDU which is associated with a corresponding logical channel and has a SN generated by a RLC protocol entity. In some aspects, the RLC protocol entity generates SNs for each RLC PDU in a consecutive order. In some aspects, identifying the packets may be performed in connection with scheduling an uplink transmission and may be associated with receiving an uplink grant. The operations of block 1110 may be performed by a receiver, a scheduler, and a communications manager as described with reference to FIGS. 7-9 and may include aspects of RLC and MAC layer functionality as described with reference to FIGS. 2 and 3.

At block 1120, the UE may determine whether use of an integrity protection code is configured for a first logical channel having packets available for uplink transmission. The first logical channel may comprise a plurality of RLC PDUs in the identified RLC PDUs, including a start segment and an end segment associated with a first SN of the first logical channel. In some aspects, the identified RLC PDUs may include packets associated with different logical channels. The operations of block 1120 may be performed by a communications manager as described with reference to FIGS. 7-9 and may include aspects of PDCP and RLC layer functionality as described with reference to FIGS. 2 and 3.

At block 1130, the UE may arrange, based on a result of the determining, a first set of RLC PDUs of the identified RLC PDUs in a first transport block such that the end segment associated with the first SN of the first logical channel is placed after a second RLC PDU of the first logical channel having a second SN that is larger than the first SN. For example, if it is determined that integrity protection is enabled for the first logical channel and that the packets of the first logical channel include segments, then the UE may arrange the RLC PDUs in the first transport block such that the end segment of the packet with the first SN is placed in the transport block after a packet with a second SN that is larger than the first SN. Each packet may include segmentation information in an RLC header by which it can be determined, for a packet with a particular SN, whether the RLC PDU includes all bytes of a corresponding RLC SDU, a first segment of the corresponding RLC SDU, or a last segment of the corresponding RLC SDU.

In one aspect, the UE may arrange a second set of RLC PDUs of the identified RLC PDUs in a second transport block such that the start segment of the packet with the first SN is placed before a third RLC PDU of the first logical channel having a third SN that is smaller than the first SN. For example, the first and second transport blocks may be scheduled for (concurrent) transmission on different component carriers in a same slot or subframe. In other aspects, the first transport block may correspond to an eMBB transmission having a relatively long duration. The second transport block may correspond to a shorter duration URLLC transmission that at least partly overlaps with the eMBB transmission. The URLLC transmission may preempt the eMBB transmission on the overlapping resources and the UE may be configured to use a modified placement with uplink transmissions on eMBB resources that are subject to such preemption. In one example, modified placement of RLC PDUs in a transport block may be based at least in part on a URLLC mini-slot configuration of the UE in which such resources are identified. The operations of block 1130 may be performed by a communications manager as described with reference to FIGS. 7-9 and may include aspects of PDCP, RLC, and MAC layer functionality as described with reference to FIGS. 2 and 3 together with aspects of the MAC subPDU placement described in connection with FIGS. 4A and 4B.

In some aspects, a modified, non-consecutive placement may be used in a streaming operating mode of the UE such that placing the end segment of the first SN packet in the transport block after the second SN packet may signify that it follows the second SN packet from a transmission time standpoint. As described herein, the modified placement may be used to create a separation in time between start and end segments to accommodate parallel packet processing. In the tail-head swapped example, the timing difference between the last bit of the first segment and the first bit of the last segment for a given integrity-protected packet may be maximized. It will be recognized, however, that use of the first and last transport block locations (e.g., the first and last MAC subPDUs) is not a requirement of the modified placement described herein. Rather, the modified placement described herein can utilize other non-consecutive SN orderings in which a segment with SN=X either precedes packets with SN<X or follows packets with SN>X when it includes a first segment or a last segment, respectively.

At block 1140, the UE may send the first transport block to the receiver. In one aspect, sending the first transport block may include sending the first TB on a first component carrier and sending the second TB on a second component carrier in a carrier aggregation configuration of the UE. In some aspects, sending the first TB to the receiver comprises sending the first TB on first resources allocated by a first resource grant associated with a first service type, and sending the second TB to the receiver comprises sending the second TB on second resources associated with a second service type which overlap, at least in part, with the first resources. The first service type may include an eMBB service and the second service type may include a URLLC service which can at least partially preempt eMBB transmissions. The operations of block 1140 may be performed by a transmitter and a communications manager as described with reference to FIGS. 7-9 and may include aspects of MAC and PHY layer functionality as described with reference to FIGS. 2 and 3.

It should be noted that the methods described above describe possible implementations, and that the operations and the steps may be rearranged or otherwise modified and that other implementations are possible. Furthermore, aspects from two or more of the methods may be combined.

### Example 1

A method of wireless communication by a UE, comprising: identifying RLC PDUs to send to a receiver, each RLC PDU being associated with a logical channel and comprising a sequence number of the logical channel generated by an RLC protocol entity of the UE; determining whether use of an integrity protection code is configured for a first logical channel, the first logical channel comprising a plurality of RLC PDUs in the identified RLC PDUs, including a first start segment and a first end segment associated with a first sequence number; arranging, based on a result of the determining, a first set of RLC PDUs of the identified RLC PDUs in a first MAC TB, wherein the first start segment is placed at the end of the first MAC TB; arranging, based on a result of the determining, a second set of RLC PDUs of the identified RLC PDUs in a second MAC TB, wherein the first end segment is placed at the beginning of the second MAC TB when the second MAC TB is in a different transmission time interval than the first MAC TB or the first end segment is placed at the end of the second MAC TB when the second MAC TB is in a same transmission time interval as the first MAC TB; and sending the first MAC TB and the second MAC TB to the receiver.

### Example 2

The method of example 1, wherein sending the first MAC TB and the second MAC TB to the receiver further comprises: sending the first MAC TB on a first component carrier in a carrier aggregation configuration of the UE; and sending the second MAC TB on the first component carrier in the carrier aggregation configuration of the UE.

### Example 3

The method of example 1 or 2, wherein sending the first MAC TB and the second MAC TB to the receiver further comprises: sending the first MAC TB on a first component carrier in a carrier aggregation configuration of the UE; and sending the second MAC TB on a second component carrier in the carrier aggregation configuration of the UE.

### Example 4

The method of any of examples 1 to 3, wherein the second MAC TB is in a different transmission time interval than the first MAC TB, and wherein the plurality of RLC PDUs is a first plurality of RLC PDUs, the method further comprising: determining whether use of the integrity protection code is configured for a second logical channel, the second logical channel comprising a second plurality of RLC PDUs in the identified RLC PDUs, including a second start segment and a second end segment associated with a second sequence number; and arranging, based on a result of the determining whether use of the integrity protection code is configured for the second logical channel, the second end segment in the second MAC TB after the first end segment.

### Example 5

The method of example 4, further comprising: arranging, based on the result of the determining whether use of the integrity protection code is configured for the second logical channel, the second start segment in a third MAC TB, wherein the third MAC TB is in the second logical channel.

### Example 6

The method of any of examples 1 to 5, further comprising: arranging the first set of RLC PDUs in a consecutive order of sequence numbers in the first TB when it is determined that use of the integrity protection code is not enabled for the first logical channel.

### Example 7

The method of any of examples 1 to 6, wherein sending the first MAC TB and the second MAC TB to the receiver further comprises: sending the first MAC TB on first resources allocated by a first resource grant associated with a first service type; and sending the second TB on second resources associated with a second service type which overlap, at least in part, with the first resources.

### Example 8

The method of any of examples 1 to 7, wherein arranging the first set of RLC PDUs, the second set of RLC PDUs, or both, is based at least in part on a logical channel configuration of the identified RLC PDUs, a segmentation of the identified RLC PDUs, an uplink transmission timing requirement associated with the first MAC TB, a number of MAC TBs to be processed concurrently, a service type for the uplink transmission, a resource allocation for the uplink transmission, or any combination thereof.

### Example 9

The method of any of examples 1 to 8, wherein the integrity protection code is at a PDCP level.

### Example 10

An apparatus comprising at least one means for performing a method of any of examples 1 to 9.

### Example 11

An apparatus for wireless communications comprising a processor; memory in electronic communication with the processor; and instructions stored in the memory and executable by the processor to cause the apparatus to perform a method of any of examples 1 to 9.

### Example 12

A non-transitory computer-readable medium storing code for wireless communications, the code comprising instructions executable by a processor to perform a method of any of examples 1 to 9.

### Example 13

A method of wireless communication by a UE, comprising: identifying RLC PDUs to send to a receiver, each RLC PDU being associated with a logical channel and comprising a sequence number (SN) of the logical channel generated by an RLC protocol entity of the UE; determining whether use of an integrity protection code is configured for a first logical channel, the first logical channel comprising a plurality of RLC PDUs in the identified RLC PDUs, including a first start segment and a first end segment associated with a first SN; arranging, based on a result of the determining, a first set of RLC PDUs of the identified RLC PDUs in a first MAC TB wherein the first end segment is placed after a second RLC PDU of the first logical channel having a second SN that is larger than the first SN; and sending the first TB to the receiver.

### Example 14

The method of example 13, further comprising: arranging a second set of RLC PDUs of the identified RLC PDUs in a second TB wherein the first start segment is placed before a third RLC PDU in the identified RLC PDUs having a third SN that is smaller than the first SN; and sending the second TB to the receiver.

### Example 15

The method of example 13 or 14, further comprising: arranging the first set of RLC PDUs in a consecutive order of SNs in the first TB when it is determined that use of the integrity protection code is not enabled for the first logical channel.

### Example 16

The method of any of examples 13 to 15, wherein sending the first TB to the receiver comprises sending the first TB on a first component carrier in a carrier aggregation configuration of the UE, and sending the second TB to the receiver comprises sending the second TB on a second component carrier in the carrier aggregation configuration of the UE.

### Example 17

The method of any of examples 13 to 16, wherein sending the first TB to the receiver comprises sending the first TB on first resources allocated by a first resource grant associated with a first service type, and sending the second TB to the receiver comprises sending the second TB on second resources associated with a second service type which overlap, at least in part, with the first resources.

### Example 18

The method of example 17, wherein the first service comprises an enhanced mobile broadband (eMBB) service and the second service comprises an ultra-reliable low latency (URLLC) service, and wherein at least a portion of the first TB is preempted by transmission of the second TB.

### Example 19

The method of any of examples 13 to 18, wherein an RLC header of the first start segment comprises an indication that the first start segment comprises a first segment of an RLC service data unit (SDU).

### Example 20

The method of example 19, wherein an RLC header of the first end segment comprises an indication that the first end segment comprises a last segment of the RLC SDU.

### Example 21

The method of any of examples 13 to 20, wherein the RLC protocol entity of the UE generates the SNs in a consecutive order.

### Example 22

The method of any of examples 13 to 21, further comprising receiving an allocation of resources comprising a plurality of OFDM symbols for sending the first TB and the second TB to the receiver, wherein the first start segment is mapped to a first OFDM symbol of the first TB and the first end segment is mapped to a second OFDM symbol of the second TB which follows the first OFDM symbol in the allocation of resources.

### Example 23

The method of any of examples 13 to 22, wherein arranging the first set of RLC PDUs, the second set of RLC PDUs, or both, is based at least in part on a logical channel configuration of the identified RLC PDUs, a segmentation of the identified RLC PDUs, an uplink transmission timing requirement associated with the first transport block, a number of transport blocks to be processed concurrently, a service type for the uplink transmission, a resource allocation for the uplink transmission, or any combination thereof.

### Example 24

An apparatus comprising at least one means for performing a method of any of examples 13 to 23.

### Example 25

An apparatus for wireless communications comprising a processor; memory in electronic communication with the processor; and instructions stored in the memory and executable by the processor to cause the apparatus to perform a method of any of examples 13 to 23.

### Example 26

A non-transitory computer-readable medium storing code for wireless communications, the code comprising instructions executable by a processor to perform a method of any of examples 13 to 23.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM).

An orthogonal frequency division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP (LTE) and LTE-Advanced (LTE-A are releases of Universal Mobile Telecommunications System (UMTS) that use E-UTRA. UTRA, E-UTRA, UMTS, LTE, LTE-A, NR, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE or an NR system may be described for purposes of example, and LTE or NR terminology may be used in much of the description, the techniques described herein are applicable beyond LTE or NR applications.

In LTE/LTE-A networks, including such networks described herein, the term evolved node B may be generally used to describe the base stations. The wireless communications system or systems described herein may include a heterogeneous LTE/LTE-A or NR network in which different types of eNBs provide coverage for various geographical regions. For example, each eNB, gNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNB, gNB, Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, gNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein-including, for example, wireless communications system 100 of FIG. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special-purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of wireless communication by a user equipment (UE), comprising:
identifying radio link control (RLC) protocol data units (PDUs) to send to a receiver, each RLC PDU being associated with a logical channel and comprising a sequence number of the logical channel generated by an RLC protocol entity of the UE;
determining whether use of an integrity protection code is configured for a first logical channel, the first logical channel comprising a plurality of RLC PDUs in the identified RLC PDUs, including a first start segment and a first end segment associated with a first sequence number;
arranging, based on a result of the determining, a first set of RLC PDUs of the identified RLC PDUs in a first media access control (MAC) transport block (TB), wherein the first start segment is placed at the end of the first MAC TB;
arranging, based on a result of the determining, a second set of RLC PDUs of the identified RLC PDUs in a second MAC TB, wherein the first end segment is placed at the beginning of the second MAC TB when the second MAC TB is in a different transmission time interval than the first MAC TB or the first end segment is placed at the end of the second MAC TB when the second MAC TB is in a same transmission time interval as the first MAC TB; and
sending the first MAC TB and the second MAC TB to the receiver.

2. The method of claim 1, wherein sending the first MAC TB and the second MAC TB to the receiver further comprises:
sending the first MAC TB on a first component carrier in a carrier aggregation configuration of the UE; and
sending the second MAC TB on the first component carrier in the carrier aggregation configuration of the UE.

3. The method of claim 1, wherein sending the first MAC TB and the second MAC TB to the receiver further comprises:
sending the first MAC TB on a first component carrier in a carrier aggregation configuration of the UE; and
sending the second MAC TB on a second component carrier in the carrier aggregation configuration of the UE.

4. The method of claim 1, wherein the second MAC TB is in a different transmission time interval than the first MAC TB, and wherein the plurality of RLC PDUs is a first plurality of RLC PDUs, the method further comprising:
determining whether use of the integrity protection code is configured for a second logical channel, the second logical channel comprising a second plurality of RLC PDUs in the identified RLC PDUs, including a second start segment and a second end segment associated with a second sequence number; and
arranging, based on a result of the determining whether use of the integrity protection code is configured for the second logical channel, the second end segment in the second MAC TB after the first end segment.

5. The method of claim 4, further comprising:
arranging, based on the result of the determining whether use of the integrity protection code is configured for the second logical channel, the second start segment in a third MAC TB, wherein the third MAC TB is in the second logical channel.

6. The method of claim 1, further comprising:
arranging the first set of RLC PDUs in a consecutive order of sequence numbers in the first TB when it is determined that use of the integrity protection code is not enabled for the first logical channel.

7. The method of claim 1, wherein sending the first MAC TB and the second MAC TB to the receiver further comprises:
sending the first MAC TB on first resources allocated by a first resource grant associated with a first service type; and
sending the second TB on second resources associated with a second service type which overlap, at least in part, with the first resources.

8. The method of claim 1, wherein arranging the first set of RLC PDUs, the second set of RLC PDUs, or both, is based at least in part on a logical channel configuration of the identified RLC PDUs, a segmentation of the identified RLC PDUs, an uplink transmission timing requirement associated with the first MAC TB, a number of MAC TBs to be processed concurrently, a service type for the uplink transmission, a resource allocation for the uplink transmission, or any combination thereof.

9. The method of claim 1, wherein the integrity protection code is at a packet data convergence protocol (PDCP) level.

10. A method of wireless communication by a user equipment (UE), comprising:
identifying radio link control (RLC) protocol data units (PDUs) to send to a receiver, each RLC PDU being associated with a logical channel and comprising a sequence number (SN) of the logical channel generated by an RLC protocol entity of the UE;
determining whether use of an integrity protection code is configured for a first logical channel, the first logical channel comprising a plurality of RLC PDUs in the identified RLC PDUs, including a first start segment and a first end segment associated with a first SN;
arranging, based on a result of the determining, a first set of RLC PDUs of the identified RLC PDUs in a first media access control (MAC) transport block (TB) wherein the first end segment is placed after a second RLC PDU of the first logical channel having a second SN that is larger than the first SN; and
sending the first MAC transport block to the receiver.

11. The method of claim 10, further comprising:
arranging a second set of RLC PDUs of the identified RLC PDUs in a second TB wherein the first start segment is placed before a third RLC PDU in the identified RLC PDUs having a third SN that is smaller than the first SN; and
sending the second TB to the receiver.

12. The method of claim 10, further comprising:
arranging the first set of RLC PDUs in a consecutive order of SNs in the first TB when it is determined that use of the integrity protection code is not enabled for the first logical channel.

13. The method of claim 12, wherein sending the first TB to the receiver comprises sending the first TB on a first component carrier in a carrier aggregation configuration of the UE, and sending the second TB to the receiver comprises sending the second TB on a second component carrier in the carrier aggregation configuration of the UE.

14. The method of claim 12, wherein sending the first TB to the receiver comprises sending the first TB on first resources allocated by a first resource grant associated with a first service type, and wherein sending the second TB to the receiver comprises sending the second TB on second resources associated with a second service type which overlap, at least in part, with the first resources.

15. The method of claim 14, wherein the first service comprises an enhanced mobile broadband (eMBB) service and the second service comprises an ultra-reliable low latency (URLLC) service, and wherein at least a portion of the first TB is preempted by transmission of the second TB.

16. The method of claim 12, wherein an RLC header of the first start segment comprises an indication that the first start segment comprises a first segment of an RLC service data unit (SDU).

17. The method of claim 16, wherein an RLC header of the first end segment comprises an indication that the first end segment comprises a last segment of the RLC SDU.

18. The method of claim 12, further comprising:
receiving an allocation of resources comprising a plurality of OFDM symbols for sending the first TB and the second TB to the receiver, wherein the first start segment is mapped to a first OFDM symbol of the first TB and the first end segment is mapped to a second OFDM symbol of the second TB which follows the first OFDM symbol in the allocation of resources.

19. The method of claim 12, wherein arranging the first set of RLC PDUs, the second set of RLC PDUs, or both, is based at least in part on a logical channel configuration of the identified RLC PDUs, a segmentation of the identified RLC PDUs, an uplink transmission timing requirement associated with the first transport block, a number of transport blocks to be processed concurrently, a service type for the uplink transmission, a resource allocation for the uplink transmission, or any combination thereof.

20. The method of claim 10, wherein the RLC protocol entity of the UE generates the SNs in a consecutive order.

21. A user equipment (UE), comprising:
a processor;
memory coupled with the processor; and
instructions stored in the memory and operable, when executed by the processor, to:
identify radio link control (RLC) protocol data units (PDUs) to send to a receiver, each RLC PDU being associated with a logical channel and comprising a sequence number of the logical channel generated by an RLC protocol entity of the UE;
determine whether use of an integrity protection code is configured for a first logical channel, the first logical channel comprising a plurality of RLC PDUs in the identified RLC PDUs, including a first start segment and a first end segment associated with a first sequence number;
arrange, based on a result of the determining, a first set of RLC PDUs of the identified RLC PDUs in a first media access control (MAC) transport block (TB), wherein the first start segment is placed at the end of the first MAC TB;
arrange, based on a result of the determining, a second set of RLC PDUs of the identified RLC PDUs in a second MAC TB, wherein the first end segment is placed at the beginning of the second MAC TB when the second MAC TB is in a different transmission time interval than the first MAC TB or the first end segment is placed at the end of the second MAC TB when the second MAC TB is in a same transmission time interval as the first MAC TB; and
send the first MAC TB and the second MAC TB to the receiver.

22. The UE of claim 21, wherein the instructions to send the first MAC TB and the second MAC TB to the receiver are further operable, when executed by the processor, to:
send the first MAC TB on a first component carrier in a carrier aggregation configuration of the UE; and
send the second MAC TB on the first component carrier in the carrier aggregation configuration of the UE.

23. The UE of claim 21, wherein the instructions to send the first MAC TB and the second MAC TB to the receiver are further operable, when executed by the processor, to:
send the first MAC TB on a first component carrier in a carrier aggregation configuration of the UE; and
send the second MAC TB on a second component carrier in the carrier aggregation configuration of the UE.

24. The UE of claim 21, wherein the second MAC TB is in a different transmission time interval than the first MAC TB, and wherein the plurality of RLC PDUs is a first plurality of RLC PDUs, the instructions stored in the memory are operable, when executed by the processor, to:
determine whether use of the integrity protection code is configured for a second logical channel, the second logical channel comprising a second plurality of RLC PDUs in the identified RLC PDUs, including a second start segment and a second end segment associated with a second sequence number; and
arrange, based on a result of the determining whether use of the integrity protection code is configured for the second logical channel, the second end segment in the second MAC TB after the first end segment.

25. The UE of claim 24, the instructions stored in the memory are operable, when executed by the processor, to:
arrange, based on the result of the determining whether use of the integrity protection code is configured for the second logical channel, the second start segment in a third MAC TB, wherein the third MAC TB is in the second logical channel.

26. The UE of claim 21, wherein the instructions stored in the memory to send the first MAC TB and the second MAC TB are further operable, when executed by the processor, to:
send the first MAC TB on first resources allocated by a first resource grant associated with a first service type; and
send the second TB on second resources associated with a second service type which overlap, at least in part, with the first resources.

27. A user equipment (UE), comprising:
a processor;
memory coupled with the processor; and
instructions stored in the memory and operable, when executed by the processor, to:
identify radio link control (RLC) protocol data units (PDUs) to send to a receiver, each RLC PDU being associated with a logical channel and comprising a sequence number (SN) of the logical channel generated by an RLC protocol entity of the UE;
determine whether use of an integrity protection code is configured for a first logical channel, the first logical channel comprising a plurality of RLC PDUs in the identified RLC PDUs, including a first start segment and a first end segment associated with a first SN;
arrange, based on a result of the determining, a first set of RLC PDUs of the identified RLC PDUs in a first transport block (TB) wherein the first end segment is placed after a second RLC PDU of the first logical channel having a second SN that is larger than the first SN; and
send the first TB to the receiver.

28. The UE of claim 27, wherein the instructions stored in the memory are operable, when executed by the processor, to:
arrange a second set of RLC PDUs of the identified RLC PDUs in a second TB wherein the first start segment is placed before a third RLC PDU in the identified RLC PDUs having a third SN that is smaller than the first SN; and
send the second TB to the receiver.

29. The UE of claim 27, wherein the instructions stored in the memory are operable, when executed by the processor, to:
arrange the first set of RLC PDUs of in the first TB in a consecutive order of SNs when it is determined that use of the integrity protection code is not enabled for the first logical channel.

30. The UE of claim 29, wherein the instructions stored in the memory are operable, when executed by the processor, to:
receive an allocation of resources comprising a plurality of OFDM symbols for sending the first TB and the second TB to the receiver, wherein the first start segment is mapped to a first OFDM symbol of the first TB and the first end segment is mapped to a second OFDM symbol of the second TB which follows the first OFDM symbol in the allocation of resources.
